(19) United States
(12) Patent Application Publication
(10) Pub. No.: US 2024/0231520 A1
(43) Pub. Date: Jul. 11, 2024

(54) PIXEL UNIT, PIXEL ARRAY AND ELECTRONIC APPARATUS HAVING SENSING FUNCTION ELEMENT AND MANUFACTURING METHOD THEREOF

(71) Applicant: Shih-Hsien Tseng, Hsinchu City (TW)

(72) Inventors: Shih-Hsien Tseng, Hsinchu City (TW); Chih-Wen Lu, Hsinchu City (TW)

(73) Assignee: Shih-Hsien Tseng, Hsinchu City (TW)

(21) Appl. No.: 18/391,613

(22) Filed: Dec. 20, 2023

Related U.S. Application Data
(60) Provisional application No. 63/434,921, filed on Dec. 22, 2022.

(51) Int. Cl. G06F 3/041; G06F 3/044

(52) U.S. Cl. CPC G06F 3/0412; G06F 3/0416; G06F 3/044

(57) ABSTRACT

The present invention relates to a pixel unit, pixel array and an electronic apparatus having sensing function element and a manufacturing method thereof, wherein the sensing function element be separated manufacturing from a pixel medium module and then coupled to one or more electrodes of the pixel medium module configured to sense, measure and/or compensate the characteristics of one or more mediums of the pixel medium module. The display medium module includes a first electrode, a second electrode and a display medium. The display medium is disposed between the first electrode and the second electrode. The sensing function element is constructed from the active switching element, the transistors of the active switching element could be constructed into a circuit diagram coupled to, the first electrode and the second electrode, and configured to sense, measure and/or compensate the characteristics of the display medium module.

### CROSS REFERENCE TO RELATED APPLICATIONS

This application claims the benefit of U.S. Provisional Application No. 63/434,921, filed on Dec. 22, 2022. The content of the application is incorporated herein by reference.

### BACKGROUND OF THE INVENTION

### 1. Field of the Invention

The present invention relates to a pixel unit, pixel array and an electronic apparatus, therein having sensing function element and a manufacturing method thereof. More specifically, wherein the sensing function element is separated and manufactured from a pixel medium module and then coupled to one or more electrodes of the pixel medium module, and configured to sense, measure or compensate the characteristics of one or more mediums of the pixel medium module. The present exemplary embodiment, though the pixel unit, the pixel array and the electronic apparatus, therein having a sensing function element and a manufacturing method of the disclosure used as an example, thereof not limited to be used in the display application and concept, thereof can be widely used in other types of electronic devices having a pixel unit or pixel array.

### 2. Description of the Prior Art

The existing display devices may be categorized into self-luminous and non-self-luminous ones. The liquid crystal display (LCD) device is the main non-self-luminous flat panel display device, wherein modulated the amount of light passing through a liquid crystal medium by controlling the voltage between the upper and lower electrodes of the liquid crystal medium; and by adding a color filter layer, a polarizer and some functional optical films, and backlight to achieve the effect of color display.

Self-luminous flat panel display devices may be categorized into field emissive display, plasma display, electroluminescent display, photoluminescent display, organic light-emitting diode display, inorganic light-emitting diode display and so on. In an organic light-emitting diode display (OLED), light-emitting polymers are deposited between an upper electrode layer and a lower electrode layer, and included a conductive layer of electrons and holes, and by means of an external electric field to move the carriers and induce the electrons and holes to re-combine for generating light. In comparison, an organic light-emitting diode display device is characterized by its wide viewing angle, fast responding speed, thin panel and flexibility; further, it neither requires backlighting nor color filter and may be made large-sized.

The display panel of both LCD and OLED devices use a transparent glass as a substrate, then directly and sequentially forming a thin-film transistor, a lower electrode layer, a display medium layer, an upper electrode layer and others thereon. The thin-film transistor may control the voltage or current imposed on the upper electrode layer and/or the lower electrode layer to control the state of the display medium. Since it is necessary to directly and sequentially form a thin film transistor, an electric conduction pattern and display medium on the glass substrate, whereon the effective area of pixel unit will be relatively compressed, difficultly to achieve the high aperture rate and the uniformity of each display pixel unit. Meantime, a glass substrate may not endure a high annealing temperature (the strain temperature of glass being around 650° C.), thereby the manufacturing process of the foregoing elements has to be performed at a relatively lower temperature (compared with single crystal poly; around 1000° C. manufacturing temperature). An amorphous Thin-Film transistor of a larger-sized panel may induce threshold voltage shift after over a period of driving time stressed or biased, thereby induced the threshold voltage variated seriously and caused the non-uniformity dimming issues; if there are not included additional sensing and/or compensating circuitry or another external display integrated circuit driving in the pixel unit.

The current flat display device pursues the precise amount of electronic energy flowing through display medium of display unit, thereof the variation in threshold voltage of the driving transistors could result in undesirable variations in display quality. That is, the characteristic of the driving transistors could be variated depending on manufacturing process variables of the driving transistor included in each pixel unit. Expectantly, that all the transistors have the same characteristics is practically impossible in manufacturing procedure of the current displays. Accordingly, the variations in threshold voltages of the driving transistor could occur and suffer non-uniform deviation of the threshold voltage of the driving thin-film transistor in each pixel unit, and the variation of driving capability according to the threshold shifting deviation. The different controlling, biasing and driving condition can induce the non-uniform driving characteristics issues of each pixel, so that a non-uniform dimness or luminance phenomenon may occur in pixel array or pixel electronic apparatus. For solving this problem, normally, the display required to implement the additional sensing circuitry and compensating for each driving thin-film transistor.

Referring to FIG. 1, a top view of a known pixel unit 1PP. The pixel unit 1PP may serve as part of a display panel for displaying a pixel part of an image; generally, the LCD pixel unit 1PP includes a glass substrate 10S, and a gate control line 11G, a data control line 12D, a thin film transistor 13T, and a pixel electrode 14PE, and comprises a common display medium and a pixel corresponding electrode are integrally and sequentially manufactured on the original or another glass substrate 10S. The thin film transistor 13T has a gate, a source, and a drain, respectively, electrically connected to the gate control line 11G, the data control line 12D, and the pixel electrode 14PE, for controlling the state of the display medium, and adjusting the luminous flux of the pixel electrode 14PE. Moreover, the organic light-emitting diode (OLED) display need more thin film transistors and capacitors for controlling and driving the display medium, there are need to implement sensing or compensating functional features being added into each pixel or implement sensing and compensating functional in external driving integrated circuit. Furthermore, each pixel unit 1PP of the display panel is integrally and sequentially formed the signal control line, the display medium, the pixel electrode, corresponding electrode (and so on) on the same glass substrate 10S. Therefore, the TFT transistor, the signal control line, the display medium, the pixel electrode, the pixel corresponding electrode and so on are not easy to replace or repair the individually for a damaged pixel unit 1PP (same issue happened on the pixel array and pixel electronic apparatus). Normally, the image operation frame of the existing display device is sequentially refreshed every time and needed to combine with the external pixel driving integrated circuit, which is located at the periphery of the display pixel unit 1PP, to refresh the image of display, to drive the thin film transistor 13T of each pixel unit 1PP and to update and write the content of each pixel unit 1PP. The larger size of the display demands the bigger glass substrate needed to form more thin film transistors 13T (i.e., larger area of the thin film transistors 13T), it is more difficult to precisely control the uniformity of the thin film transistor 13T in the pixel unit 1PP (Such as the threshold voltage, current drive capability). The thin-film transistor manufacturing process has been suffered the disadvantages of the required expensive tools, the process steps became complicated, the manufacturing time became longer, a large number of the thin-film transistors needed be made up the sensing and compensating circuitry to sense or compensate the threshold swift, and induced the manufacturing cost increasing and the mass production quality and the yield control became less stability. Furthermore, it has been a long-time issue for accomplishing one or multi-layer display media, manufacturing of one or multi-facet display and repairing part of the damaged display device.

In view of the foregoing, a pixel unit, pixel array and an electronic apparatus still have existing various disadvantages to overcome.

### SUMMARY OF THE INVENTION

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure encompass a variety of aspects to serve as a pixel unit, pixel array and pixel electronic apparatus, therein having sensing and/or compensating function element; although the pixel unit, pixel array and electronic apparatus of the disclosure and the method thereof are not limited to be used in the display device, and the method and concept thereof can be widely used in other types of electronic devices having a pixel unit, pixel array and pixel electronic apparatus (e.g. using in sensing touch pixel, image sensing pixel, pressure sensing pixel, photoelectronic pixel so on). The display pixel unit, pixel array and pixel electronic apparatus are only used as an example, and the disclosure are not limited thereto.

It is an object of the present invention relates to display pixel unit, display pixel array and display electronic apparatus comprise a display medium module and a sensing function element, therein the sensing function element constructed from one or more active switching elements, and separated manufacturing from the display medium module and then electrically coupled to one or more electrodes of the display medium module configured in order to sense, measure and/or compensate the characteristics of the display medium of the display medium module. Furthermore, the sensing function element could be applied in the display pixel unit, pixel array and pixel electronic apparatus to improve one of the disadvantages of existing display devices, for example, to reduce objectionable visible nonuniformity in large-sized panel, to improve the manufacturing yield rate, to improve the mobility of driving transistor, to cancel the complicated circuity in the pixel unit for sensing and compensating the threshold shift of thin-film transistor and so on.

The present invention provides a display pixel unit, pixel array and display electronic apparatus, thereof comprising a separately manufactured the sensing function element constructed from the active switching element, wherein the active switching element comprises a substrate portion and transistors portion, and the transistors portion formed on the substrate portion and constructed into one or more gain stages and/or feedback loop, and/or combined with one or more passive elements; and a display medium module therein the sensing function element electrically coupled to the electrodes of the display medium module configured to sense, measure and compensate the characteristics of the display medium of the display medium module directly. Thereof, the display medium module comprises one or more pairs of electrodes and one or more display mediums, and each pair of electrodes comprises a first electrode and a second electrode, wherein the first electrode and the second electrode are separated from each other, and the display medium is disposed between the first electrode and the second electrode.

To achieve the foregoing object, the present invention provides a manufacturing method for manufacturing a display pixel unit, pixel array and pixel electronic apparatus according to the present invention, comprising the following steps: separately manufacturing a display medium module and a sensing function element, wherein the sensing function element constructed from one or more active switching elements and electrically coupled to the display medium module, and configured to sense, measure, and/or compensate the characteristics of the display medium module directly; then assembling the sensing function element with the display medium module, wherein the display medium module comprises one or more pairs of electrodes and one or more display mediums, and each pair of electrodes comprises a first electrode and a second electrode, wherein the first electrode and the second electrode are separated from each other, and the display medium is disposed between the first electrode and the second electrode. Furthermore, the sensing function element electrically coupled to the first electrode of the display medium module and configured to provide electric energy between the first electrode and the second electrode to sense, measure and/or compensate the characteristics of the display medium module.

Thus, a display pixel unit, pixel array and pixel apparatus and a manufacturing method thereof according to the present invention could provide at least the following advantageous effects: the previously manufactured sensing function element is constructed from the active switching element, and then being assembled with the display medium module; that is, the sensing function element is not manufactured on some portion of the display medium module directly. As such, the manufacturing process condition of the sensing function element could not be restricted by the characteristics of the display medium module (EX. limited by glass material property). Furthermore, the sensing function element constructed from the active switch element could be manufactured on wafer or any other substrate. For the processing technique of wafer is more matured and advanced, therefore, the sensing function elements manufactured on wafers have better characteristics (single crystal transistor have a higher yield rate, stable threshold voltage or a faster mobility rate of electron compared with amorphous TFT transistor).

On the other hand, the display pixel unit, pixel array could be independently disposed, assembled and disassembled. In this case of a display electronic apparatus is composed of a plurality of pixel unit or pixel array structures, the damaged pixel unit or pixel array structure could be disassembled and replaced by the new ones. As such, there is no need to replace the entire display panel for the single damaged pixel unit or pixel array structure.

An embodiment of the present invention also provides another configuration of pixel array. The pixel array comprises a display medium module, a sensing function element and a connecting module. The display medium module comprises one or more pairs of electrodes and one or more display mediums, wherein each pair of electrodes comprises a first electrode and a second electrode, and separated from each other, and the display medium is disposed between the first electrodes and the second electrodes of the display medium module. The sensing function element constructed from the active switching element, wherein the active switching element comprises a substrate portion and transistors portion, and the transistors portion formed on the substrate portion and constructed into one or more gain stages and/or feedback loop and/or combined with one or more passive elements (e.g. resistor, capacitor, so on), then through the connecting module electrically coupled to first electrodes of the display medium and configured to provide electric energy between the first electrodes and the second electrodes to sense, measure and/or compensate the characteristics of the display medium. The connecting module comprises a plurality of conductors for electrically connecting the sensing function element to first electrodes of the display medium module.

Another embodiment of the present invention provides a display electronic apparatus, which comprises a plurality of pixel arrays. Each pixel array comprises a display medium module, a sensing function element and a connecting module. The display medium module comprises one or more pairs of electrodes and one or more display mediums, and each pair of electrodes comprises a first electrode and a second electrode, and separated from each other, and the display medium is disposed between the first electrodes and the second electrodes of the display medium module. The sensing function element is constructed from active switching elements, therein comprises a substrate portion and transistors portion and the transistors portion formed on the substrate portion, wherein the transistors constructed into one or more gain stages and/or feedback loop and combined with one or more passive elements (e.g. resistor, capacitor, so on), then through the connecting module electrically coupled to first electrodes of the display medium and configured to provide electric energy between the first electrodes and the second electrodes to sense, measure and/or compensate the characteristics of the display medium. The connecting module comprises a plurality of conductors for electrically connecting the sensing function element to first electrodes of the display medium module.

Another embodiment of the present invention provides a method for manufacturing a pixel array. The method comprises separately forming a display medium module of the pixel array, individually forming the display medium module comprises one or more pairs of electrodes and one or more display mediums, and each pair of electrodes comprises a first electrode and a second electrode, and separated from each other, and the display medium is disposed between the first electrodes and the second electrodes of the display medium module; individually forming a sensing function element constructed from one or more active switching element, wherein the active switching element comprises a substrate portion and transistors portion and the transistors portion formed on the substrate portion, wherein the transistors constructed into one or more gain stages and/or feedback loop and combined with one or more passive elements (e.g. resistor, capacitor, so on), therein the sensing function element through the connecting module electrically coupling to first electrodes and configuring provide electric energy between the first electrodes and the second electrodes to sense, measure and/or compensate the characteristics of the display medium; and forming a connecting module comprises a plurality of conductors for electrically connecting the sensing function element constructed into the active switching element to first electrodes of the display medium module.

The foregoing objects, technical features and advantages of the present invention will become apparent after the following detailed description of preferred embodiments in conjunction with the attached drawings.

These and other objectives of the present invention will no doubt become obvious to those of ordinary skill in the art after reading the following detailed description of the preferred embodiment that is illustrated in the various figures and drawings.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a top view of a known pixel unit.

FIG. 2A is a top view of a pixel unit according to an embodiment of the present invention.

FIG. 2B is a cross-section view of the pixel unit along the line 2B-2B′ in FIG. 2A.

FIG. 2C is a cross-section views of another embodiment along the line 2B-2B′ in FIG. 2A.

FIG. 3A to FIG. 3B are cross-section views of another pixel array according to another embodiment of the present invention.

FIG. 4A to FIG. 4B are cross-section views of a pixel unit according to another embodiment of the present invention.

FIG. 5 is a top view of a display apparatus according to the embodiment of the present invention.

FIG. 6A is a cross-section view of a pixel array according to the embodiment of the present invention along the line 7-7′ in FIG. 5.

FIG. 6B is a cross-section view of a display apparatus according to the embodiment of the present invention along the line 9A-9A′ in FIG. 5.

FIG. 7A is a flow diagram showing a manufacturing method of a pixel unit according to the embodiment of the present invention.

FIG. 7B is a flow diagram showing a manufacturing method of a pixel array according to the embodiment of the present invention.

FIG. 7C is a flow diagram showing a manufacturing method of a display apparatus according to the embodiment of the present invention.

FIG. 8 shows a top view of a display apparatus according to another embodiment of the present invention.

FIG. 8A is a cross-section view of the display apparatus along the line 16-16′ in FIG. 8.

FIG. 8B is a cross-section view of a pixel array according to another embodiment of the present invention.

FIG. 9 is a sensing function element schematic circuit sensing the capacitance characteristics of the display medium of the present invention.

FIG. 9A shows the waveforms of the switch control signal and the modulated voltage of the sensing function element circuit schematic in FIG. 9.

FIG. 10 is another embodiment of sensing function element schematic circuit sensing the capacitance characteristics of the display medium of the present invention.

FIG. 10A shows the waveforms of the switch control signals and the modulated voltages of the sensing function element circuit schematic in FIG. 10.

FIG. 11 is another embodiment of sensing function element schematic circuit sensing the capacitance characteristics of the display medium of the present invention.

FIG. 11A shows the waveforms of the switch control signals and the modulated voltages of the sensing function element circuit schematic in FIG. 11.

FIG. 12 is another embodiment of sensing function element schematic circuit sensing the capacitance characteristics of the display medium of the present invention.

FIG. 12A shows the waveforms of the switch control signals and the modulated voltages of the sensing function element circuit schematic in FIG. 12.

FIG. 13 is another embodiment of sensing function element schematic circuit sensing the capacitance characteristics of the display medium of the present invention.

FIG. 13A shows the waveforms of the switch control signals and the modulated voltages of the sensing function element circuit schematic in FIG. 13.

FIG. 14 is another embodiment of sensing function element schematic circuit sensing the capacitance characteristics of the display medium of the present invention.

FIG. 14A shows the waveforms of the switch control signals and the modulated voltages of the sensing function element circuit schematic in FIG. 14.

FIG. 15 is an embodiment of sensing function element schematic circuit sensing the characteristics of the display medium of the present invention.

FIG. 15A shows the waveforms of the switch control signal and the output voltages of the sensing function element circuit schematic in FIG. 15.

FIG. 16 is another embodiment of sensing function element schematic circuit sensing the characteristics of the display medium of the present invention.

FIG. 17 is another embodiment of sensing function element schematic circuit sensing the characteristics of the display medium of the present invention.

FIG. 18 is another embodiment of sensing function element schematic circuit sensing the characteristics of the display medium of the present invention.

FIG. 19 is an embodiment of sensing function element schematic circuit sensing the characteristics of the display medium of the present invention.

FIG. 19A shows the waveforms of the switch control signal and the output voltages of the sensing function element circuit schematic in FIG. 19.

FIG. 20 is a diagram of a touch electronic display apparatus sensing system of an embodiment of the present invention for sensing capacitances of touch and display devices.

FIG. 21 shows a diagram of the touch electronic display apparatus sensing system of an embodiment of the present invention for sensing capacitances of touch and display devices in FIG. 20.

FIG. 22 shows another diagram of the touch electronic display apparatus sensing system of an embodiment of the present invention for sensing capacitances of touch and display devices in FIG. 20.

FIG. 23 is a sensing circuit diagram of an embodiment of the present invention for sensing the capacitances of the touch electronic display apparatus.

FIG. 24 shows a sensing circuit diagram for sensing the selected capacitance in FIG. 23.

FIG. 24A shows the waveforms of the switch control signals and the modulated voltages of the sensing circuit diagram in FIG. 24.

FIG. 25 is another sensing circuit diagram of another embodiment of the present invention for sensing the capacitances of the touch electronic display apparatus.

FIG. 25A shows a sensing circuit diagram for sensing the selected capacitance in FIG. 25.

FIG. 25B is a waveform diagram of the operation of the sensing circuit in FIG. 25A.

FIG. 26 shows a schematic diagram for sensing, driving, measuring and/or compensating the characteristics of the display medium of the present invention referred from FIG. 2 to FIG. 25.

FIG. 26A is another schematic diagram for sensing, driving, measuring and/or compensating the characteristics of the display medium of the present invention referred from FIG. 2 to FIG. 25.

FIG. 26B shows another schematic diagram for sensing, driving, measuring and/or compensating the characteristics of the display medium of the present invention referred from FIG. 2 to FIG. 25.

FIG. 27 shows a measured I-V curve characteristics of the display medium module of the present invention referred from FIG. 2 to FIG. 26B.

FIG. 28 shows a measured C-V curve characteristics of the display medium module of the present invention referred from FIG. 2 to FIG. 26B.

### DETAILED DESCRIPTION

The implementation of the present invention will be further illustrated by way of the following description of a plurality of embodiments. But it should be noted that the embodiments described below are illustrative and exemplary only rather than limiting the application of the present invention to the described environment, application, structure, procedure or steps. Elements that are not directly related to the present invention are ignored from the drawings. The scale relations among elements in the drawings are illustrated rather than limiting of the actual scales of the present invention. Unless noted otherwise, identical (or similar) reference symbols correspond to identical (or similar) elements.

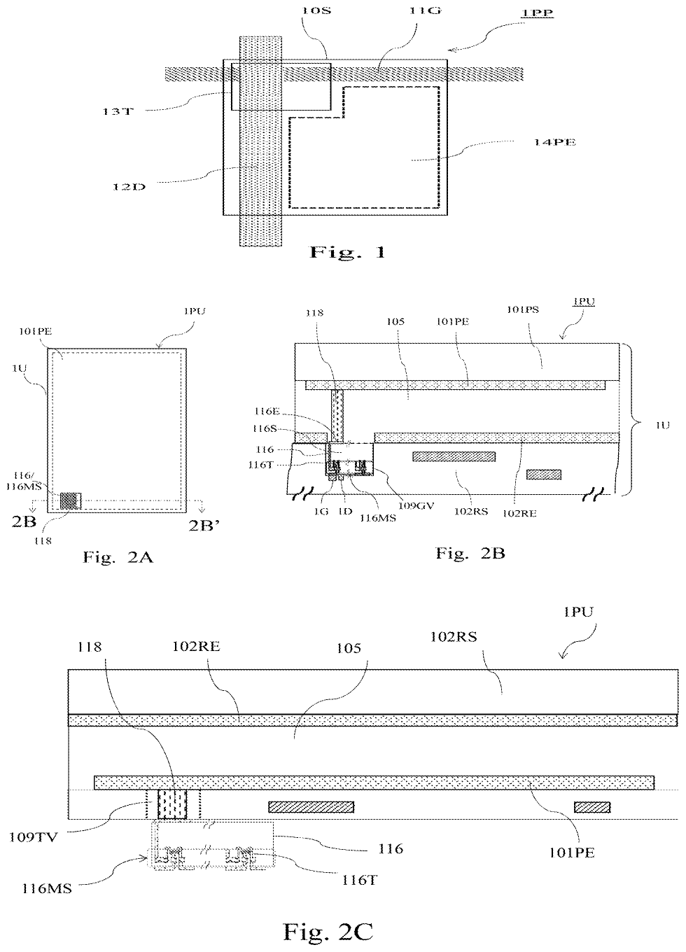

Please refer to FIG. 2A, showing a top view of a pixel unit 1PU according to an embodiment of the present invention. The pixel unit 1PU may serve as part of a display pixel array or display electronic apparatus to display a pixel part of an image; that is, a display array or display electronic apparatus may include one or a plurality of pixel units 1PU according to the present embodiment. The pixel unit 1PU may include a sensing function element 116MS (an active switching element 116) and a display medium module 1U. The sensing function element 116MS constructed from the active switching element 116, wherein the active switching element 116 comprises a substrate portion and transistors portion, and the transistors portion formed on the substrate portion and constructed into one or more gain stages and/or feedback loop and combined with one or more passive elements (e.g. resistor, capacitor, so on), and then electrically coupled to first electrodes of the display medium and configured to provide electric energy between the first electrodes and the second electrodes to sense , measure and/or compensate the characteristics of the display medium for precisely adjusting the amount of light passing through a display medium module 1U (or modulating the properties of light). More specific technical contents will be illustrated below.

Please refer to FIG. 2B is a cross-section view along the line 2B-2B′ of the pixel unit in FIG. 2A. FIG. 2C is cross-section view along the line 2B-2B′ of differently configured pixel unit according to different embodiments of the present invention. Wherein, the active switching element 116 comprises a substrate portion 116S and transistors portion 116T, and the transistor portion 116T are formed on the active switching element substrate portion 116S. That is, the transistor portion 116T is a part of an active switching element substrate 116S, thereof could be glass, quartz, metal, metal oxide, silicon, silicon dioxide on insulator, germanium, gallium arsenide, gallium nitride, three-five compound, two-six compound, four-four compound, four-four alloy, amorphous silicon, organic flexibility, inorganic and the combination of the above (used silicon substrate in the following illustrations), and the transistor portion 116T is formed by a series of semiconductor processes (exposure, development, etching, diffusion, deposition, ion implantation, cleaning, inspection, etc.) on the active switching element substrate 116S. A plurality of the transistor portion 116T of the active switching elements 116 could be simultaneously formed on the active switching element substrate 116S, wherein the active switching elements 116 could be constructed into a sensing function element 116MS for sensing, measuring and/or compensating the characteristics of the display medium module 1U or be constructed into another functional elements (image compensating, touch sensing, image processing, data transmitting or receiving, data storing, power generation, and so on), and then the active switching element substrate 116S may be divided into a plurality of portions (with each part including one or more transistor portions 116T) by a cutting process, thereof each part is the active switching element 116 described above. Furthermore, the active switching element 116 include a plurality of electric conductors and electrodes 116E formed on the upper or lower surfaces of the substrate portion 116S, the transistor portion 116T, and the source, the gate, and the drain of the transistor portion 116T; thereof could be electrically connected to each other. The active switching element 116 may also be regarded as a chip or die.

Further, the display medium module 1U in FIG. 2A to FIG. 2C comprises one or more pairs of electrodes and a display medium 105. The pair of electrodes includes a first electrode 101PE and a second electrode 102RE, and the first electrode 101PE and the second electrode 102RE are separated from each other and may face each other, and the display medium 105 is disposed between the first electrode 101PE and the second electrode 102RE. The first electrode 101PE and the second electrode 102RE may also be referred to as a pixel electrode or a pixel corresponding electrode, and could be a non-transparent, partially transparent or transparent electrode (e.g. formed of a metal oxide, a nano silver wire, a conductive polymer, carbon nanotubes and graphene). Electrical energy could be imposed on the first electrode 101PE or the second electrode 102RE to change the magnitude and/or the direction of the voltage, current, inductance, capacitance, electrical field, and magnetic field between the first electrode 101PE and the second electrode 102RE and one of the combinations thereof.

The first electrode 101PE may also be electrically connected to the sensing function element 116MS (e.g. via the electrode 116E of the active switching element 116 and/or another set of electrical conductors 118), thereof the sensing function element 116MS can control the electrical energy is to be imposed on the first electrode 101PE and/or the second electrode 102RE, and configured to sense, measure and/or compensate the characteristics of the display medium 105 of the display medium module 1U.

The display medium 105 may also be called light modulation medium. Its state could be changed via the first electrode 101PE and the second electrode 102RE to control the amount of light passing through (or modulate the properties of light). Specifically, the active switching element 116 (The sensing function element 116MS) could control the electrical energy imposed on the first electrode 101PE and/or the second electrode 102RE, adjust the voltage, current and electric field between the first electrode 101PE and the second electrode 102RE to change the state of the display medium 105. If a display medium 105 made of non-self-luminous liquid crystal, change in the state of the display medium 105 means torsional rearrangement of the liquid crystal molecules. In case of a display medium 105 made of self-luminous organic light-emitting diode, change in the state of the display medium 105 means by the applied electric field magnitude to move the carriers for inducing the electrons and the holes carrier recombination phenomenon to produce light intensity and color. The type of the display medium 105 is relevant to the configuration of the first electrode 101PE and the second electrode 102RE. For example, if the display medium 105 is in-plane-switching liquid crystal, the first electrode 101PE and the second electrode 102RE may be arranged on the same plane.

Besides non-self-luminous and self-luminous medium materials, in other embodiments the display medium 105 may further comprise color filter material, conductive material, insulating material, light absorbing material, light reflecting material, photo refractive material, light deflecting material, light diffusing material and at least one of the foregoing materials (the foregoing materials may be formed on the first substrate 101PS and/or the second substrate 102RS described below, or may be formed into a plate body previously being disposed on the surfaces of the first substrate 101PS and/or the second substrate 102RS). Thereof, the non-self-luminous medium materials include at least one of electrophoretic material, electric fluid material, liquid crystal material, micro electromechanical reflective material, electrowetting material, electric ink material, quantum dot material, magnetic fluid material, electrochromic material, electromorphous material and thermochromic material; and the self-luminous medium materials could include at least one of electroluminescent material, photoluminescent material, cathodoluminescent material, field emissive luminescent material, phosphorescent material, quantum dot material, fluorescent material and light-emitting diode material for producing white, Green, blue, orange, indigo, purple, yellow or combinations thereof.

The display medium module 1U may also include a first substrate 101PS and/or a second substrate 102RS, which are disposed facing each other and separate from each other and are used for supporting the first electrode 101PE, a second electrode 102RE and/or a display medium 105. The first electrode 101PE could be disposed on the first substrate 101PS, the second electrode 102RE may be disposed on the first substrate 101PS and/or the second substrate 102RS (depending on the type of the display medium 105), and the display medium 105 may be disposed between the first substrate 101PS and the second substrate 102RS (or, when the display medium module 1U comprises only one of the first substrate 101PS and the second substrate 102RS, the display medium 105 could be disposed on either the first substrate 101PS or the second substrate 102RS). The sensing function element 116MS (the active switching element 116) could be disposed on the first substrate 101PS and/or the second substrate 102RS, but not directly manufactured on the first substrate 101PS and/or the second substrate 102RS; that is, the sensing function element 116MS (the active switching element 116) is separately and previously manufactured then being assembled to the first substrate 101PS and/or the second substrate 102RS. Furthermore, the sensing function element 116MS (the active switching element 116) could be disposed on one of the upper surfaces, lower surfaces, any surfaces, the inside, the groove 109GV, the perforation 109TV, and the combination of the first substrate 101PS and/or the second substrate 102RS, so that the pixel aperture ratio of the first electrode 101PE is less compressed by the active switching element 116.

The first substrate 101PS, the second substrate 102RS, the first electrode 101PE, and the second electrode 102RE could be made from the following materials (but not limited to): transparent material, opaque material, flexible material, rigid material, metallic material, ceramic material, insulating material, metal compound material, metal alloy material, organic material, inorganic material, composite material, semiconductor material and one of the combinations thereof. In the present embodiment, the first substrate 101PS and the second substrate 102RS are made of transparent material (such as silicon).

The foregoing flexible material may include: polyethylene naphthalate (PEN), polyvinyl chloride (PVC), polyether sulfone (PES), polyethylene terephthalt (PET), polyarylate (PAR), polystyrene (PS), polycarbonate (PC), polyimide (PI), polymethyl methacrylate (PMMA), polyacrylonitrile (PAN), polyamide (PA) and one of the combinations thereof.

The pixel unit 1PU may also include a control signal line 1G and a data signal line 1D, which may be formed on or in the surface of the first substrate 101PS and/or the second substrate 102RS and electrically connected to the sensing function element 116MS (the active switching element 116), thereof, the control signal line 1G, data signal line 1D, first electrode 101PE and/or second electrode 102RE could be made of the following materials (but not limited to): transparent conductive material, non-transparent conductive material, flexible conductive material, rigid conductive material, metallic conductive material, metal compound material, metal alloy material, organic conductive material, inorganic conductive material, and composite conductive material, and one of the combinations thereof.

As illustrated above, the active switching element 116 is fabricated on the active switching element substrate 116S, rather than directly manufactured on the first substrate or second substrate of the display medium module 1U. Therefore, the manufacturing of the active switching element 116, same as the sensing function element 116MS constructed from the active switching element 116, is not restricted by the characteristics of the display medium module 1U itself.

It has been noted above that described display array or display electronic apparatus device having a display function comprising a plurality of pixel units 1PU. In this type of configuration, the first substrate 101PS of the pixel units 1PU may be connected and integrated or the second substrate 102RE also be connected and integrated to serve as a pixel corresponding electrode.

The foregoing description illustrates the technical content of a pixel unit 1PU according to the present embodiment. The technical content of the pixel units according to other embodiments of the present invention is described below. The technical content of the pixel unit in each of these embodiments could be cross-referenced, so identical description is omitted or simplified.

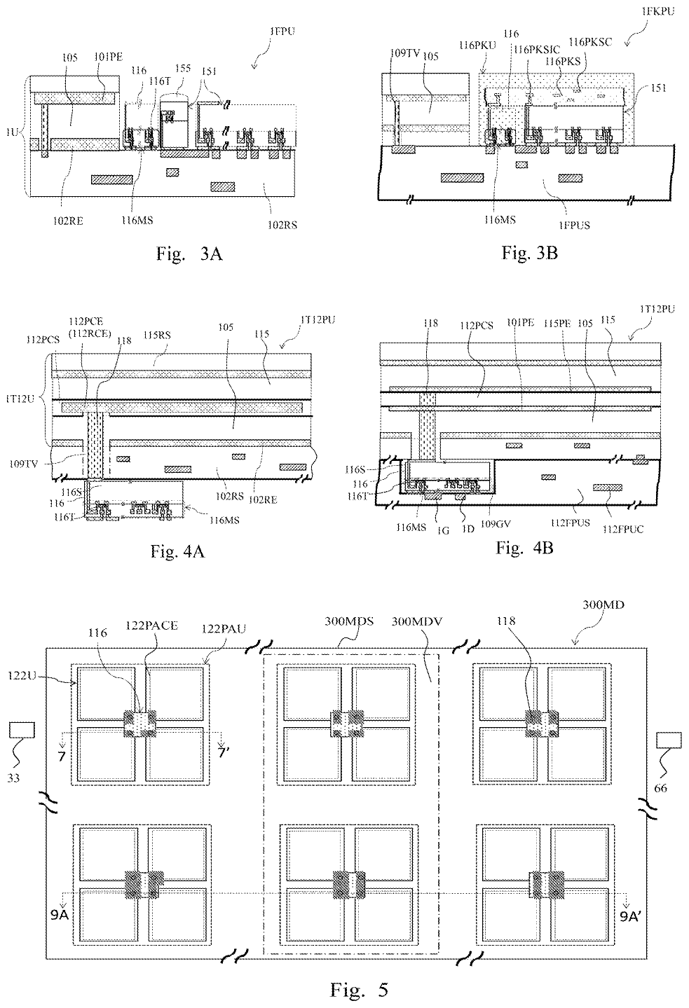

Please refer to FIG. 3A showing a cross-section view of a pixel unit 1FPU according to another embodiment of the present invention. The pixel unit 1FPU is similar to the pixel unit 1PU, both including the sensing function element 116MS be constructed from the active switching element 116, and a display medium module 1U. The pixel unit 1FPU further comprises one or a plurality of functional elements 151 (a plurality of functional elements 151 are employed as an example in the present embodiment).

The plurality of functional elements 151 are electronic elements each having a specific function (but not limited to), for example: one of a touch sensing functional element, a displacement sensing functional element, a pressure sensing function, a hygrothermal sensing functional element, an acoustic sensing functional element, an electromagnetic sensing functional element, an image capturing functional element, a memory functional element, a control functional element, a wireless communication functional element, a self-luminous functional element, a passive functional element (inductor, resistor, capacitor or a combination thereof) and a photovoltaic functional element. The pixel unit 1FPU could comprise one or a plurality of optical elements 155 corresponding to the optically related functional elements 151 (e.g., image capture function elements). The optical element 155 may comprise one or more a convex lens, a concave lens and an optical prism for changing the direction of ambient light illumination to be received by the functional elements 151.

The foregoing functional element 151 with the function of wireless communication could be the following types (but not limited to): radio frequency (RF) wireless transmission, Zigbee wireless transmission, blue-tooth communication, infrared ray, wireless fidelity (Wi-Fi) wireless transmission, personal area networks (PAN), local area networks (LAN), near field communication (NFC), radio frequency identification system (RFID), global for mobile communication (GSM) and worldwide interoperability for microwave access (WiMAX), long-term evolution (LTE), 6th generations wireless communications, 6th generations wireless and various types of wireless communication methods and one of the combinations thereof.

The touch sensing functional element may include: a photo-sensing element, a piezoelectric sensing element, a capacitance sensing element, a resistance sensing element, an inductance sensing element, an electromagnetic sensing element, an electric charge sensing element, a voltage sensing element, a current sensing element, a pressure sensing element, an acoustic sensing element and the combination thereof.

The one or more functional elements 151 may be disposed on the first substrate 101PS and/or the second substrate 102RS, and is not directly formed on some portion of the display medium module 1U. That is, the functional elements 151 are separately and previously manufactured, and then being assembled on the display medium module 1U. Similarity, the functional elements 151 also could be manufactured independently without the restriction from the characteristics of the display medium module 1U. The functional elements 151 may be electrically connected to the active switching element 116, the control signal line 1G, or the data signal line 1D for achieving the controlling functions of the functional elements 151, being controlled by the functional elements 151, transmitting signals to the functional elements 151, or receiving signals from the functional elements 151.

If integrated with the functional elements 151, the pixel unit 1FPU could provide other functions besides image display (image compensating, image capturing, touch sensing, image processing, data transmitting or receiving, data storing, power generating, image controlling and so on). For example, an image capturing functional element may enable the pixel unit 1FPU to capture part of an image; a data storing functional element may record the state of the pixel medium 105 or the data of the recording function element 151 itself; a control functional element could control the active switching element 116; a wireless communication functional element could directly transmit the pixel content or the data of various functional elements, and wirelessly transmit and receive data from the wireless control module 33 of the electronic apparatus (which will be further described in the embodiments below); a photovoltaic functional element may convert ambient light illumination into electrical power and so on.

Please refer to FIG. 3B, showing another cross-section view of a pixel unit 1FKPU according to another embodiment of the present invention. The pixel unit 1FKPU could optionally further include a package carrier 116PKU, therein packaged the sensing function element 116MS (the active switching element 116) and/or functional elements 151, before the package carrier 116PKU assembled to the display medium module 1U. That is, the sensing function 116MS constructed from the active switching element 116, and the functional element 151 manufactured from the same active switching element substrate 116S or another substrate, thereof be firstly packaged in a package carrier 116PKU or directly assembled by a carrier plate of the pixel unit 1FKPU to the display medium module 1U. The sensing function 116MS (the active switching element 116) and functional elements 151 manufactured on the same active switching element substrate 116S (or on different substrate) and then packaged together in the package carrier 116FKU. The package carrier 116PKU could protect the sensing function element 116MS constructed from the active switching element 116, and the functional elements 151 can facilitate the process of assembling them to the display medium module 1U.

The manufacturing material of the package carrier 116PKU may include (but not limited to): semiconductor material, conductive material, insulating material, organic material, inorganic material, metallic material, metallic alloy material, ceramic material, compound material, transparent material, opaque material, flexible material, rigid material, non-metallic material, and one of the combinations thereof. The package carrier 116PKU could also include a substrate 116PKS, a conductive line, a conductive connecting pad 116PKSC, a conductive connecting pole 116PKSIC, a conductive connecting bump, a conductive connecting joint, an insulating medium layer, an insulating medium, an adhesive medium, a connecting wire, or a combination thereof, and so on.

Please refer to FIGS. 4A and 4B, showing a cross-section view of a pixel unit 1T12PU according to another embodiment of the present invention. The pixel unit 1T12PU is similar to the pixel unit 1PU, and comprises the sensing function element 116MS be constructed from the active switching element 116, a display medium module 1T12U having one or more display medium (only shown two display media 105, 115 as an example), a carrier board 112FPUS, a pixel unit common substrate 112PCS and/or a pixel corresponding common substrate 112RCS. Furthermore, the first substrate 101PS of a pixel unit 1T12PU, a pixel unit common substrate 112PCS, a pixel corresponding common substrate 112RCS and/or the substrate 102RS could include a perforation 109TV and/or a groove 109GV.

Specifically, the carrier board 112FPUS allow the display medium module 1T12U to be disposed thereon or embedded therein (the sensing function element 116MS/the active switching element 116 also the same). The carrier board 112FPUS could also include a circuit conductive pad 112FPUC, a wire line, and other elements for the display medium module 1T12U and the active switching element 116 electrically connecting to each other. The control signal line 1G and the data signal line 1D may also be formed on the carrier board 112FPUS and electrically connected to the sensing function element 116MS (the active switching element 116).

Furthermore, the carrier board 112FPUS may include a concave groove 109GV (or perforation 109TV do not show). The first substrate 101PS of the display medium module 1T12U, the pixel unit common substrate 112PCS, the pixel correspondence common substrate 112RCS, and/or the second substrate 102RS could also include a perforation 109TV, and then the sensing function element 116MS (the active switching element 116) could be disposed in the concave groove 109GV; thereof electrically connected to the first electrode 101PE, the pixel unit common electrode 112PCE and/or the second electrode 102RE by a conductor 118 disposed in the perforation 109TV. The concave groove 109GV in the carrier board 112FPUS may also comprise a sidewall insulating layer, a conductive wire, a conductive pad, a conductor, an insulating medium, or a combination thereof, let the active switching element 116 be electrically connected or isolated from other elements. Through the disposition of the carrier board 112FPUS facilitates the electrical connection arrangement easier among the elements of the pixel unit 1T12PU, particularly when the pixel unit 1T12PU comprises a plurality of functional elements.

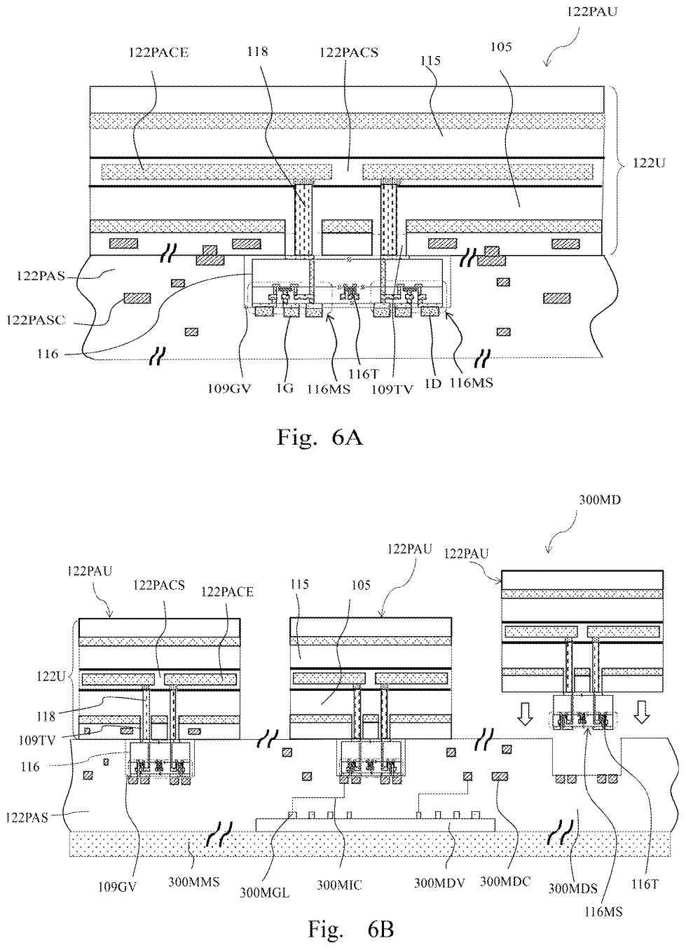

Please refer FIG. 6A showing a cross-section view of the pixel array 122PAU according to another embodiment of the present invention along the line 7-7′ of top view FIG. 5 (an electronic apparatus; 300MD). The pixel array 122PAU includes a plurality of pixel units similar to the pixel units 1T12PU, 1FPU, 1PU, etc., thereof comprises a sensing function element 116MS constructed from the active switching element 116, wherein the active switching element 116 comprises a substrate portion 116S and transistors portion 116T, and the transistors portion 116T formed on the substrate portion 116S and constructed into one or more gain stages and/or feedback loop, and combined with one or more passive elements (e.g. resistor, capacitor, so on); and a display medium module 122U having one or more pixel units include electrodes, display medium 105, 115 (only two pixel units and two display media are shown as examples), a pixel array carrier board 122PAS and a pixel array common substrate 122PACS. Thereof, the sensing function element 116MS electrically coupled to first electrodes of the display medium and configured to provide electric energy between the first electrodes and the second electrodes to sense, measure and/or compensate the characteristics of the display medium, and precisely adjust the amount of light passing through a display medium module (or modulating the properties of light). Furthermore, the transistor portion 116T among the active switching elements 116 of the pixel array 122PAU could have two independent sensing function elements 116MS for controlling the display media of the respective pixel units (the contents of the pixel units and/or the pixel unit common electrodes are respectively controlled in a synchronous or asynchronous manner by the sensing function elements 116MS).

Specifically, the pixel array carrier board 122PAS is provided for the display medium module 122U to dispose on it, and the sensing function element 116MS could be disposed on the pixel array carrier board 122PAS, and constructed from the active switching element 116, wherein the active switching element 116 comprises a substrate portion and transistors portion, and the transistors portion formed on the substrate portion and constructed into one or more gain stages and/or feedback loop and combined with one or more passive elements (e.g. resistor, capacitor, so on), and then electrically coupled to first electrodes of the display medium and configured to provide electric energy between the first electrodes and the second electrodes to sense , measure and/or compensate the characteristics of the display medium. The pixel array carrier board 122PAS further comprises a conductive pad 122PASC, a conductive circuit, a control signal line 1G, and a data signal line 1D and so on, so that the display medium module 122U and the active switching element 116 could be electrically connected to each other.

On the other hand, the pixel array carrier board 122PAS could comprise a concave groove (or perforation non shown), and then the active switching element 116 wherein the transistors 116T of the active switching element 116 could be constructed into a sensing function element 116MS and electrically coupled to the first electrode configured to sense, measure and/or compensate the characteristics of the display medium, could be installed in the concave groove 109GV electrically connected to the pixel array common electrode 122PACE (or the aforementioned first electrode or the second electrode) through the conductor 118 of the first substrate of the display medium module 1220. The concave groove 109GV of the pixel array carrier board 122PAS may still contain a sidewall insulating layer, a conductive line, a conductive pad, a conductor, an insulating medium, or a combination thereof. By the configuration of the pixel array carrier board 122PAS, the electrical connection layout between the elements of the pixel array 122PAU should be easier, especially when the pixel array 122PAU contains the aforementioned plurality of functional elements. Particularly, when the pixel array 122PAU contains the plurality of functional elements and the package carrier described above, it can be easily integrated into the wired and/or wireless communication data transmission mode, the aforementioned plurality of functional elements and/or the package carrier, etc., in a wired and/or wireless communication transmission mode, and accomplish controlling the contents of the pixel electrodes and/or the pixel unit common electrode in a synchronous or asynchronous manner.

Please refer to FIG. 6B showing a cross-section view of another embodiment of the present invention along the line 9A-9A′ of top view FIG. 5 (an electronic apparatus; 300MD). The electronic apparatus 300MD includes a plurality of pixel arrays 122PAU, a display apparatus substrate 300MDS, and a magnetic substrate 300MMS. The display apparatus substrate 300MDS may include a concave groove 109GV (or perforation do not show), a magnetic induction 300MGL, a conductive line 300MIC, a conductive pad 300MDC, a conductive post, a conductive bump, a conductive connection, an insulating medium, an adhesive medium or the like one of the combinations, by the foregoing elements on the display apparatus substrate 300MDS to cause the electrical connection between the elements of the pixel array 122PAU easier, especially when the pixel array 122PAU contains a plurality of functional elements. Wherein the pixel array 122PAU can be separately assembled into the concave groove 109GV of the display apparatus substrate 300MDS (or deposed on any surface of the display apparatus substrate 300MDS, not shown in Figs) and configured in individual loading and unloading pattern, and each pixel array 122PAU is not connected to each other pixel arrays 122PAU, so that each pixel array 122PAU can be individually removed from the electronic apparatus 300MD. Thus, when a pixel array 122PAU is damaged, it can be disassembled and then replaced with a normal pixel array 122PAU without the need to replace the entire set of electronic apparatus 300MD.

The combinations of the display medium module shapes of all the different constructed pixel units, pixel arrays, and display electronic apparatus could be the following shapes (not limited to): square, rectangular, fan, triangular, trapezoidal, circular, rhombus, rectangle, regular polygon, a polygon, irregular shape or a combination thereof. And the combination of the shapes of the first electrodes 101PE, the second electrodes 102RE, the pixel electrodes, and/or the pixel unit common electrode in the above-described display medium modules could be the following shapes (not limited to): square, rectangular, fan, triangle, trapezoid, circle, rhombus, rectangle, regular polygon, polygon, irregular shape or a combination thereof. Alternatively, a geometric pattern (e.g., square, rectangle, fan, triangle, trapezoid, circle, rhombus, rectangle, regular polygon, polygon, irregular shape, etc.) may be provided on the pixel electrode to enhance the display performance of the display medium.

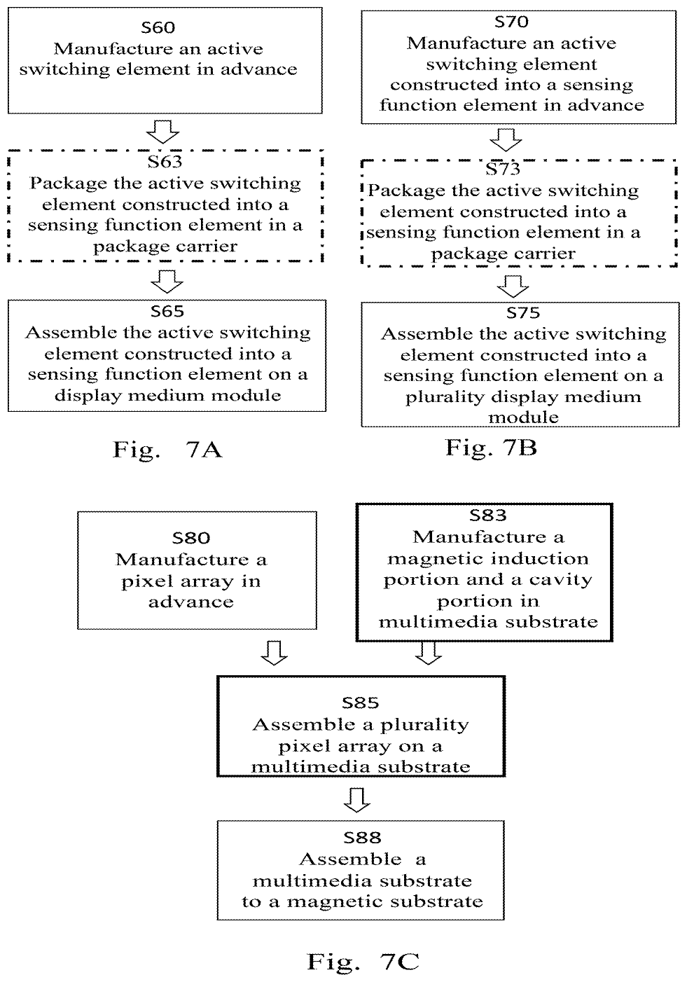

Please refer to FIG. 7A (and, 7B), showing a flow diagram of a manufacturing method of a pixel unit (FIG. 7A) and pixel array (FIG. 7B). Thereof, the present invention the manufacturing method may produce one or more identical or similar pixel units 1PU, 1FKPU, 1FPU, and 1T12PU of the above embodiments. Therefore, the technical contents of the manufacturing method and the technical content of the pixel units 1PU, 1FKPU, and be 1FPU, 1T12PU could cross-referenced.

As step S60/S70 shows, firstly manufacturing an pre-manufactured sensing function element 116MS constructed from the active switching element 116, wherein the active switching element 116 comprises a substrate portion 116S and transistors portion 116T, and the transistors portion 116T formed on the substrate portion 116S and constructed into one or more gain stages and/or feedback loop; and combined with one or more passive elements (e.g. resistor, capacitor, so on); in contrast with a display medium module of a pixel unit, the sensing function element 116MS is independently manufactured, rather than being directly manufactured on the display medium module.

Next, as Step S65/S75 shows, assembling the pre-manufactured sensing function element 116MS (the active switching element 116) on the display medium module 1U, 1T12U or 122U, and then electrically coupled to first electrodes of the display medium and configured to provide electric energy between the first electrodes and the second electrodes to sense, measure and/or compensate the characteristics of the display medium. In Step S65/S75, the functional elements 151 also could be simultaneously assembled to the display medium module. Further, before performing Step S65/S75, the pre-manufactured sensing function element 116MS and the functional elements 151 could be optionally packaged in a package carrier (e.g., in Step S63/S73). Therefore, if there is no need of a package carrier, S63/S73 may be omitted.

Please refer to FIG. 7C, showing a flow diagram of a manufacturing method of a display apparatus according to another embodiment of the present invention. The manufacturing method could produce one or a plurality of identical (similar) electronic apparatus 300MD, the multimedia display device 300MDD and the multimedia speaker device 300MSP of the above embodiments. Therefore, the technical contents of the manufacturing method and the technical content of the electronic apparatus 300MD, the multimedia display device 300MDD and the multimedia speaker device 300MSP may be cross-referenced.

As step S80 shows, firstly manufacturing a pixel array 122PAU individually; as step S83, a display electronic apparatus substrate including a magnetic induction unit 300MGL and a cavity 300MDV is also manufactured in the same time, and the pixel array is independently manufactured, rather than directly on the display apparatus substrate made out. Then, in step S85, the finished pixel array 122PAU is arranged in an independent loading and unloading pattern (none of the elements of the pixel array 122PAU is integrally connected), assembled in the multimedia substrate 300MDS. In step 88, the display electronic apparatus substrate 300MDS is assembled and bonded together with a magnetic substrate 300MMS so that the magnetic induction unit 300MGL can be electrically connected to the active switching element 116 of the pixel array 122PAU for controlling the magnetic induction unit 300MGL current magnitude, speed and direction to cause the multimedia substrate 300MDS and the magnetic substrate 300MMS producing different attraction or rejection force magnitude and speed, to generate vibrations of different sounds from the magnetic substrate 300MMS and/or the multimedia substrate 300MDS, and to match an image shown on the pixel array 122PAU can be used as a multimedia device having a loudness function and a lightness. In addition to multimedia display devices 300MDD can be applied to computers, mobile phones and other electronic products, can also be used in vehicles, wearing objects, buildings, advertising, advertising billboards and other items needed any additional display and voice features.

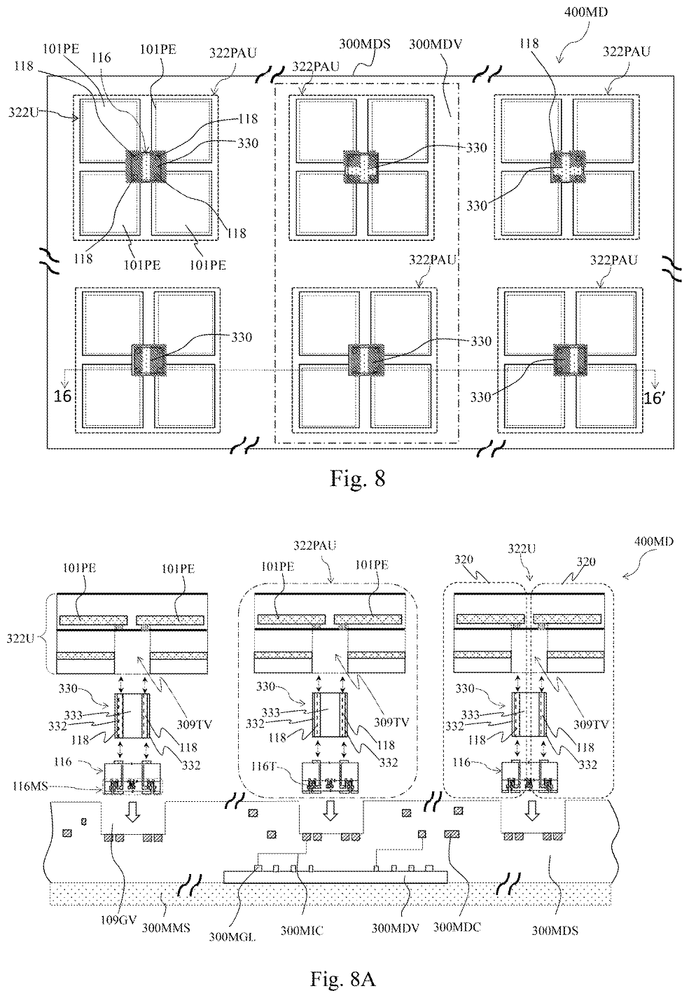

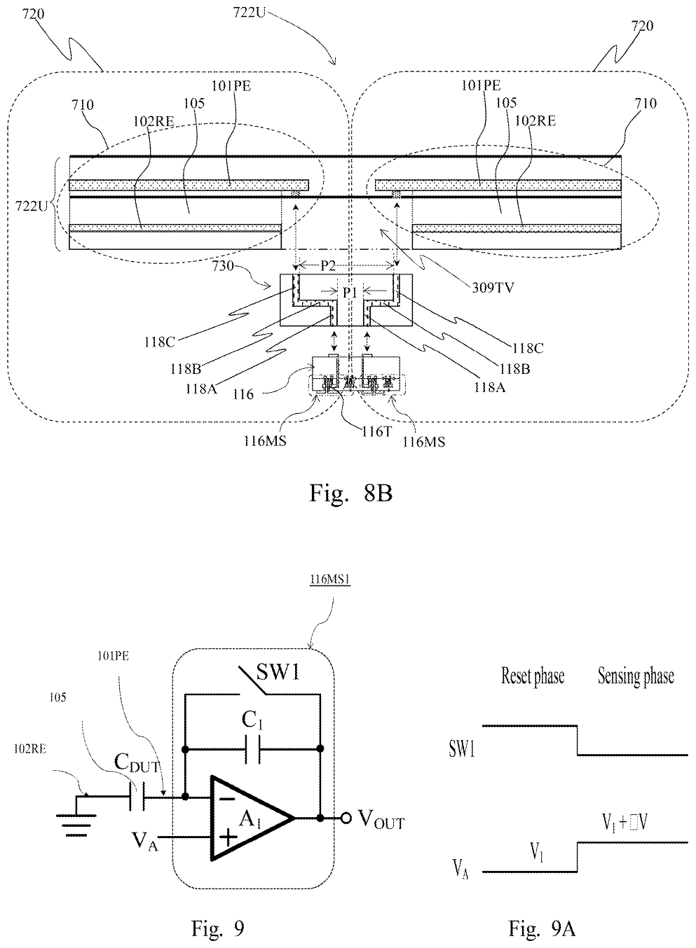

Please refer to FIG. 8 shows a top view of a electronic apparatus 400MD according to another embodiment of the present invention. FIG. 8A is a cross-section view of another embodiment of the present invention along the line 16-16′ of FIG. 8 (a display electronic apparatus 400MD). The display electronic apparatus 400MD comprises the abovementioned display apparatus substrate 300MDS, the magnetic substrate 300MMS, and a plurality of pixel arrays 322PAU of the electronic apparatus 400MD. Each of the pixel arrays 322PAU comprises a display medium module 322U, a connecting module 330, and a sensing function element 116MS. Furthermore, the pixel arrays 322PAU is optionally disposed in a perforation 309TV, in a groove 109GV or on any surfaces of the multimedia substrate 300MDS (no limited shown on FIG. 8A only; other options shown in reference U.S. Pat. No. 10,930,631). The display medium module 322U comprises at least two pairs 310 of electrodes and a display medium 105. Each pair 310 of electrodes comprises a first electrode 101PE and a second electrode 102RE. One of the first electrodes 101PE and the second electrodes 102RE could be connected or integrated to serve as a pixel corresponding electrode. In the embodiment, the display medium module 322U has four pairs 310 of electrodes, but the present invention is not limited thereto. The display medium 105 is disposed between the first electrodes 101PE and the second electrodes 102RE of the display medium module 322U. The sensing function element 116MS constructed from the active switching element 116, wherein the active switching element 116 comprises a substrate portion 116S and transistors portion 116T, and the transistors portion 116T formed on the substrate portion 116S and constructed into one or more gain stages and/or feedback loop and combined with one or more passive elements (e.g. resistor, capacitor, so on), and then through the connecting module 330 electrically coupled to first electrodes of the display medium and configured to provide electric energy between the first electrodes and the second electrodes to sense , measure and/or compensate the characteristics of the display medium 105 for precisely adjusting the amount of light passing through the display medium 105 or controlling a state of the display medium 105 (or modulating the properties of light). The connecting module 330 comprises a plurality of conductors 118 for electrically connecting between the electrodes of the display medium 322U and the sensing function element 116MS.

FIG. 8B is a cross-section view of another embodiment of the present invention of the pixel arrays 322PAU. The connecting module 330 could be characterized as an interposer in FIG. 8B, wherein could be disposed, assembled, bonded, combined, merged, associated, linked, embedded or integrated with the display medium module 322U and/or the sensing function element 116MS (not only limited shown on FIG. 8B; other alternatives shown in reference U.S. Pat. No. 10,930,631). Furthermore, the connecting module 330 could be a pitch connector disposed on any surface of the display medium module 322U of the pixel array 322PAU (no limited shown on FIG. 8B only; other alternatives shown in reference U.S. Pat. No. 10,930,631). The pitch P1 between two conductors 118A connecting with the sensing function element 116MS is less than the pitch P2 between two conductors 118C connecting with the first electrodes 101PE. The connecting module 330 could be separately manufactured and then combined with the sensing function element 116MS or the display medium module 322U. Another optional manufacturing methods is as parts of the sensing function element 116MS or the display medium module 322U at the same time.

FIG. 9 is a sensing function element schematic circuit 116MS1 for sensing, measuring and/or compensating the characteristics of the display medium 105 from FIG. 2A to 2C of the present invention. The sensing function element schematic circuit 116MS1 is a capacitor measurement schematic circuit implemented on the display medium 105 (Device Under Test: C_{DUT}), such as the liquid crystal disposed between the first electrode 101PE and the second electrode 102RE of the display medium module. The sensing function element schematic circuit 116MS1 comprise a switch SW1 and a differential amplifier A1 constructed from the transistors 116T of the active switching element 116; and a switched capacitor C1. The switched capacitor C1 and switch SW1 are electrically coupled to both the inverting input terminal and output terminal of the differential amplifier A1 to form a closed loop, the first electrode 101PE of the capacitor C_{DUT} electrically coupled to the inverting input terminal of the differential amplifier A1, and the second electrode 102RE of the capacitor C_{DUT} electrically connected to ground (shown in FIG. 9) or a dc voltage (not shown in FIG. 9). By modulating the voltage VA, electrically coupled to the non-inverting input terminal of the differential amplifier A1, and controlling the switch SW1; then through measuring the output voltage of the differential amplifier to measure the capacitance of the capacitor C_{DUT}.

FIG. 9A shows a control signal waveforms of the switch SW1 and a modulated voltage VA waveforms of the differential amplifier A1 (of the sensing function element schematic circuit 116MS1 in FIG. 9). The sensing function element schematic circuit 116MS1 is a capacitance sensing circuit of the present invention for sensing, measuring and/or compensating the characteristics of the display medium 105, such as the non-emissive liquid crystal. Two phases are required for sensing the capacitor C_{DUT} (display medium 105), wherein are reset phase and sensing phase. During the reset phase, the switch SW1 is turned on and the modulated voltage VA is modulated to V1. Therefore, the switched capacitor C1 is discharged and the charge of the switched capacitor C1 will be discharged to zero finally, and meantime assuming that the gain of the differential amplifier A1 is infinity. Because of the closed loop formed by the turned-on switch SW1, finally, the voltage of the capacitor C_{DUT} is charged to V1 and the charge on the capacitor C_{DUT} is accumulated to V1×C_{DUT}. As the sensing function element circuit schematic 116MS1 enters into the sensing phase, the switch SW1 is turned off and the modulated voltage VA would be modulated to V1+ΔV from V1; then the charges on the capacitor C_{DUT} and the switched capacitor C1 begin to be redistributed. Because of the closed loop formed by the switched capacitor C1, the voltage of the inverting input terminal of the differential amplifier A1 will be settled to V1+ΔV, the charge on the capacitor C_{DUT} will be accumulated to (V1+ΔV)×C_{DUT}, and the charge of the switched capacitor C1 will be accumulated to (V1+ΔV−V_{OUT})×C1. Because of the conservation of charge, the total charge of the capacitor C_{DUT} and the switched capacitor C1 should be the same during both the reset phase and sensing phase. That is:

$$( {V}_{1} + Δ V - {V}_{out} ) {C}_{1} + ( {V}_{1} + Δ V ) {C}_{DUT} = {V}_{1} {C}_{DUT} \qquad ( 1 )$$

From Equation (1), the output voltage Vₒᵤₜ of the sensing function element circuit schematic 116MS1 can be obtained as:

$${V}_{o u t} = {V}_{1} + Δ V + \frac{Δ V}{{C}_{1}} {C}_{DUT} \qquad ( 2 )$$

where the term of (V1+ΔV) is a dc voltage, and the gain of the sensing function element schematic circuit 116MS1 is ΔV/C1. The capacitor C_{DUT} can be evaluated from the output voltage V_{OUT}. From Equation (2), the expression of the capacitor C_{DUT} can be expressed as:

$${C}_{DUT} = ( {V}_{OUT} - {V}_{1} - Δ V ) \frac{{C}_{1}}{Δ V} \qquad ( 3 )$$

Therefore, setting an appropriate value for switched capacitor C1, and applying appropriate values of V1 and ΔV, the capacitor C_{DUT} can be measured and evaluated according to the Equation (3).

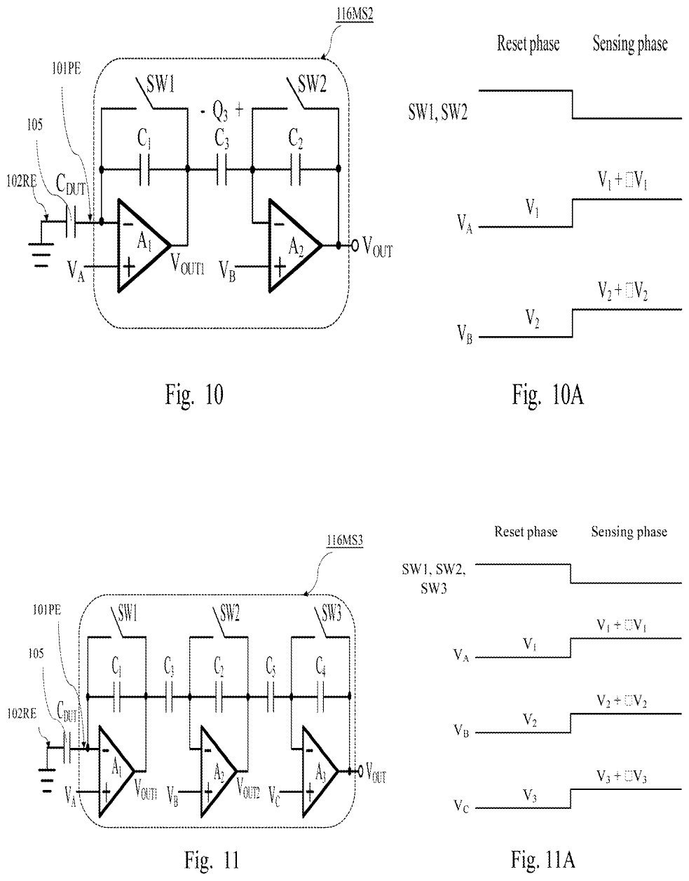

To increase the sensitivity of the capacitance sensing function element schematic circuit 116MS1 of FIG. 9 can be extended to a two-stage capacitance sensing function element schematic circuit 116MS2 as shown in FIG. 10. The sensing function element schematic circuit 116MS2 comprise a first sensing stage wherein comprises comprise a switch SW1 and a differential amplifier A1, are constructed from the transistors 116T of the active switching element 116; a switched capacitor C1; a second sensing stage wherein comprises a differential amplifier A2 and a switch SW2, are constructed from the transistors 116T of the active switching element 116; a switched capacitor C2; and a coupling capacitor C3. For the first sensing stage of the function element schematic circuit 116MS2, the switched capacitor C1 and switch SW1 are electrically coupled to both the inverting input terminal and output terminal of the differential amplifier A1 to form a closed loop. The first electrode 101PE of the capacitor C_{DUT} (display medium 105) is electrically coupled to the inverting input terminal of the differential amplifier A1. The second electrode 102RE of the capacitor C_{DUT} is connected to ground (shown in FIG. 10) or a dc voltage (not shown in FIG.). A modulated voltage VA is electrically coupled to the non-inverting input terminal of the differential amplifier A1. For the second sensing stage of the function element schematic circuit 116MS2, the switch capacitor C2 and switch SW2 are electrically coupled to both the inverting input terminal and output terminal of the differential amplifier A2 to form a closed loop. A modulated voltage VB is electrically coupled to the non-inverting input terminal of the differential amplifier A2. The coupling capacitor C3 is electrically coupled to the output terminal of the first sensing stage and the inverting input terminal of the second sensing stage of the function element schematic circuit 116MS2. Thereof, the coupling capacitor C3 is electrically coupled to the output terminal VOUT1 of the differential amplifier A1 and the inverting input terminal of the differential amplifier A2. By modulating the voltages of VA and VB, controlling the switches SW1 and SW2, and measuring the output voltage VOUT of the differential amplifier A2, the capacitance of C_{DUT} can be evaluated.

FIG. 10A shows a control signal waveforms of the switches SW1 and SW2 and a modulated voltages VA and VB waveforms of the differential amplifier A1 and A2 (of the sensing function element schematic circuit 116MS2 shown in FIG. 10). Two phases are required for sensing the capacitance of C_{DUT}, wherein are reset phase and sensing phase. During the reset phase, the switches SW1 and SW2 are turned on, and the modulated voltage of VA is modulated to V1, another modulated voltage of VB is modulated to V2. The switched capacitors C1 and C2 are discharged, finally, the charges of both switched capacitor C1 and C2 will be discharged to zero. Assuming that the gains of both the differential amplifiers A1 and A2 are infinity. Because of the closed loop formed by the turned-on switch SW1 and A1, the voltages of both the capacitor of C_{DUT} and the output voltage of the differential amplifier A1 are charged to V1, and the charge accumulated on the capacitor C_{DUT} is V1×C_{DUT}. Because of the closed loop formed by the turned-on switch SW2 and A2, the voltages of the inverting input terminal and the output terminal of the differential amplifier A2 are charged to V2. The charge Q3 accumulated on coupling capacitor C3 is (V2−V1)×C3. As the sensing function element schematic circuit 116MS2 enters into the sensing phase, the switches SW1 and SW2 are turned off, and the modulated voltage VA would be modulated to V1+ΔV1 from V1, meantime another modulated voltage of VB is modulated to V2+ΔV2 from V2. Then the charges on the capacitor C_{DUT}, the switched capacitor C1, C2 and the coupling capacitor C3 begin to be redistributed. Because of the closed loop formed by the switched capacitor C1 and the differential amplifier A1, the voltage of the inverting input terminal of the differential amplifier A1 will be settled to V1+ΔV1. The charge accumulated on capacitor C_{DUT} will be (V1+ΔV1)×C_{DUT}, and the charge of the switched capacitor C1 will be charged to (V1+ΔV1−V_{OUT1})×C1, wherein V_{OUT1} is the output voltage of the differential amplifier A1. Because of the closed loop formed by the switched capacitor C2 and the differential amplifier A2, the voltage of the inverting input terminal of the differential amplifier A2 will be settled to V2+ΔV2. The charge accumulated on the switched capacitor C2 will be charged to (V2+ΔV2−V_{OUT})×C2, and the charge of the coupling capacitor C3 will be charged to (V2+ΔV2−V_{OUT1})×C3, wherein V_{OUT} is the output voltage of the differential amplifier A2. Because of the conservation of charge, the total charge of the measured capacitor C_{DUT} and the switched capacitor C1 should be the same during both the reset phase and sensing phase. The equation of the charge conservation can be expressed as:

$$( {V}_{1} + {Δ V}_{1} - {V}_{OUT 1} ) {C}_{1} + ( {V}_{1} + {Δ V}_{1} ) {C}_{DUT} = {V}_{1} {C}_{DUT} \qquad ( 4 )$$

From Equation (4), the output voltage V_{OUT1} of the differential amplifier A1 can be obtained as:

$${V}_{OUT 1} = {V}_{1} + {Δ V}_{1} + {Δ V}_{1} \frac{{C}_{DUT}}{{C}_{1}} \qquad ( 5 )$$

Because of the conservation of charge, the total charge of the switched capacitor C2 and the coupling capacitor C3 should be the same during both the reset phase and sensing phase. The equation of the charge conservation can be expressed as:

$$( {V}_{2} + {Δ V}_{2} - {V}_{OUT} ) {C}_{2} + ( {V}_{2} + {Δ V}_{2} - {V}_{OUT 1} ) {C}_{3} = ( {V}_{2} - {V}_{1} ) {C}_{3} \qquad ( 6 )$$

From Equations (5) and (6), the output voltage V_{OUT} of the sensing function element schematic circuit 116MS2 can be obtained as:

$${V}_{OUT} = {V}_{2} + {ΔV}_{2} - ( {ΔV}_{1} - {ΔV}_{2} ) \frac{{C}_{3}}{{C}_{2}} - \frac{{C}_{3}}{{C}_{2}} \frac{{ΔV}_{1}}{{C}_{1}} {C}_{DUT} \qquad ( 7 )$$

where the term of

$$[ {V}_{2} + {ΔV}_{2} - ( {ΔV}_{1} - {ΔV}_{2} ) \frac{{C}_{3}}{{C}_{2}} ]$$

is a dc offset voltage, and the two-stage gain of the sensing function element schematic circuit 116MS2 is

$$- \frac{{C}_{3}}{{C}_{2}} \frac{{ΔV}_{1}}{{C}_{1}} .$$

The two-stage gain of the sensing function element schematic circuit 116MS2 can be increased by the capacitance ratio of C3 and C2. The capacitance of the measured-capacitor C_{DUT} can be evaluated from the output voltage V_{OUT}. From Equation (7), the expression of the capacitor C_{DUT} can be expressed as:

$${C}_{DUT} = [ - {V}_{OUT} + {V}_{2} + {ΔV}_{2} - ( {ΔV}_{1} - {ΔV}_{2} ) \frac{{C}_{3}}{{C}_{2}} ] \frac{{C}_{2}}{{C}_{3}} \frac{{C}_{1}}{{ΔV}_{1}} \qquad ( 8 )$$

Therefore, setting an appropriate value for the switched capacitor C1, C2, and the coupling capacitor C3 and applying appropriate values of V1, Δ1, V2, and Δ2, the capacitance of the measured capacitor C_{DUT} can be measured and evaluated according to the Equation (8). If the values of Δ1 and Δ2 are set to be the same and are ΔV, the output voltage V_{OUT} of the sensing function element 116MS2 schematic circuit can be expressed as:

$${V}_{OUT} = {V}_{2} + ΔV - \frac{{C}_{3}}{{C}_{2}} \frac{ΔV}{{C}_{1}} {C}_{DUT} \qquad ( 10 )$$

The output dc offset voltage is reduced to (V2+ΔV). Equation (8) can be expressed as:

$${C}_{DUT} = [ - {V}_{OUT} + {V}_{2} + ΔV ] \frac{{C}_{2}}{{C}_{3}} \frac{{C}_{1}}{ΔV} \qquad ( 11 )$$

To further increase the sensitivity of the sensing function element schematic circuit 116MS2 of FIG. 10 can be extended to a three-stage capacitance sensing function element schematic circuit 116MS3 as shown in FIG. 11. The sensing function element schematic circuit 116MS3 comprises a first sensing stage wherein comprise a switch SW1 and a differential amplifier A1, are constructed from the transistors 116T of the active switching element 116; a switched capacitor C1; a second sensing stage wherein comprises a differential amplifier A2 and a switch SW2, are constructed from the transistors 116T of the active switching element 116; a switched capacitor C2; a third sensing stage wherein comprises a differential amplifier A3 and a switch SW3, are constructed from the transistors 116T of the active switching element 116; a switched capacitor C4; and two coupling capacitors C3 and C5. For the first-stage sensing circuit, the switched capacitor C1 and switch SW1 are electrically coupled to both the inverting input terminal and output terminal of the differential amplifier A1 to form a closed loop. The first electrode 101PE of the capacitor C_{DUT} (display medium 105) is electrically coupled to the inverting input terminal of the differential amplifier A1. The second electrode 102RE of the capacitor C_{DUT} is connected to ground (shown in FIG. 11) or a dc voltage (not shown in FIG.). A modulated voltage VA is electrically coupled to the non-inverting input terminal of the differential amplifier A1. For the second-stage sensing circuit, the switch capacitor C2 and switch SW2 are electrically coupled to both the inverting input terminal and output terminal of the differential amplifier A2 to form a closed loop. A modulated voltage VB is electrically coupled to the non-inverting input terminal of the differential amplifier A2. A coupling capacitor C3 is electrically coupled between the output terminal of the first-stage sensing circuit and the input of the second-stage sensing circuit. That is: the coupling capacitor C3 is electrically coupled to the output terminal V_{OUT1} of the differential amplifier A1 and the inverting input terminal of the differential amplifier A2. For the third-stage sensing circuit, the switch capacitor C4 and switch SW3 are electrically coupled to both the inverting input terminal and output of the differential amplifier A3 to form a closed loop. A modulated voltage VC is electrically coupled to the non-inverting input terminal of the differential amplifier A3. A coupling capacitor C5 is electrically coupled between the output of the second-stage sensing circuit and the input of the third-stage sensing circuit. That is: the coupling capacitor C5 is electrically coupled to the output V_{OUT2} of the differential amplifier A2 and the inverting input terminal of the differential amplifier A3. By modulating the voltages of VA, VB, and VC, controlling the switches SW1, SW2, and SW3, measuring the output voltage VOUT of the differential amplifier A3, and the capacitance of the capacitor C_{DUT} can be evaluated.

FIG. 11A shows the control signal waveforms of the switches SW1, SW2, and SW3, and the modulated voltages waveforms of VA, VB, and VC (in the sensing function element schematic circuit 116MS3 shown of FIG. 11). The sensing function element schematic circuit 116MS3 is a capacitance sensing circuit of the present invention for sensing, measuring and/or compensating the characteristics of the display medium 105, such as the non-emissive liquid crystal. Two phases are required for sensing the capacitance of under test capacitor C_{DUT}, wherein are reset phase and sensing phase. The operation of the three-stage capacitance sensing function element schematic circuit 116MS3 is similar to that of the two-stage capacitance sensing function element schematic circuit 116MS2. The relationship between the output voltage of the sensing circuit and the capacitance of under test capacitor C_{DUT} can be found accordingly and expressed as:

$${V}_{OUT} = {V}_{3} + {ΔV}_{3} - ( {ΔV}_{2} - {ΔV}_{3} ) \frac{{C}_{5}}{{C}_{4}} - ( {ΔV}_{1} - {ΔV}_{2} ) \frac{{C}_{3}}{{C}_{2}} \frac{{C}_{5}}{{C}_{4}} - \frac{{C}_{3}}{{C}_{2}} \frac{{C}_{5}}{{C}_{4}} \frac{{ΔV}_{1}}{{C}_{1}} {C}_{DUT} \qquad ( 12 )$$

where the term of

$$[ {V}_{3} + {ΔV}_{3} - ( {ΔV}_{2} - {ΔV}_{3} ) \frac{{C}_{5}}{{C}_{4}} - ( {ΔV}_{1} - {ΔV}_{2} ) \frac{{C}_{3}}{{C}_{2}} \frac{{C}_{5}}{{C}_{4}} ]$$

is a dc offset voltage, and the gain of the sensing circuit is

$$\frac{{C}_{3}}{{C}_{2}} \frac{{C}_{5}}{{C}_{4}} \frac{{ΔV}_{1}}{{C}_{1}} .$$

The gain of the sensing circuit can be increased further by increasing both the capacitance ratio of C3 and C2, and the capacitance ratio of C5 and C4. The capacitance C_{DUT} can be evaluated from the output voltage VOUT. From Equation (12), the expression of the capacitance C_{DUT} Can be expressed as:

$${C}_{DUT} = [ \text{} {V}_{OUT} - {V}_{3} - {ΔV}_{3} + ( {ΔV}_{2} - {ΔV}_{3} ) \frac{{C}_{5}}{{C}_{4}} + ( {ΔV}_{1} - {ΔV}_{2} ) \frac{{C}_{3}}{{C}_{2}} \frac{{C}_{5}}{{C}_{4}} ] \frac{{C}_{2}}{{C}_{3}} \frac{{C}_{4}}{{C}_{5}} \frac{{C}_{1}}{{ΔV}_{1}} \qquad ( 13 )$$

Therefore, setting an appropriate value for C1, C2, C3, C4, and C5, and applying appropriate values of V1, Δ1, V2, Δ2, V3, and Δ3, the capacitance C_{DUT} can be measured and evaluated according to the Equation (13). If the values of Δ1, Δ2, and Δ3 are set to be the same and are ΔV, the output voltage VOUT of the sensing function element 116MS3 schematic circuit can be expressed as:

$${V}_{OUT} = {V}_{3} + ΔV - \frac{{C}_{3}}{{C}_{2}} \frac{{C}_{5}}{{C}_{4}} \frac{ΔV}{{C}_{1}} {C}_{DUT} \qquad ( 14 )$$

The output dc offset voltage is reduced to (V3+ΔV). Equation (14) can be expressed as:

$${C}_{DUT} = [ {V}_{OUT} - {V}_{3} - ΔV ] \frac{{C}_{2}}{{C}_{3}} \frac{{C}_{4}}{{C}_{5}} \frac{{C}_{1}}{ΔV} \qquad ( 15 )$$

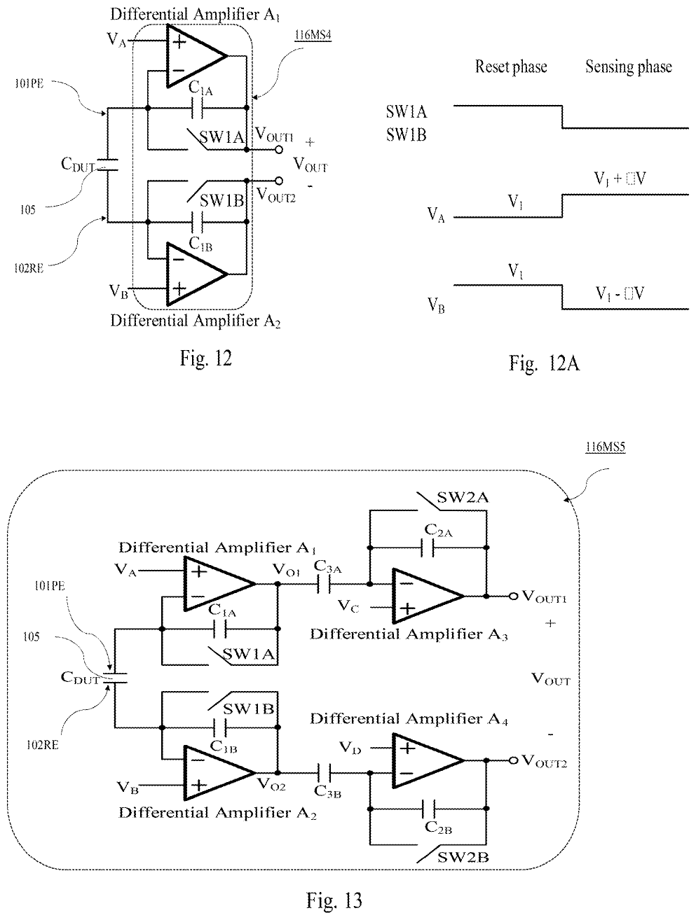

To increase the signal-to-noise ratio of the sensing function element schematic circuit 116MS1 of FIG. 9 can be modified to a fully differential capacitance sensing function element schematic circuit 116MS4 as shown in FIG. 12. The sensing function element schematic circuit 116MS4 is a capacitor measurement schematic circuit (Device Under Test: C_{DUT}/display medium 105), such as the liquid crystal disposed between the first electrode 101PE and the second electrode 102RE of the display medium 105, wherein comprise two differential amplifiers A1 and A2 and two switches SW1A and SW1B, are constructed from the transistors 116T of the active switching element 116; and two switched capacitors C1A and C1B. The switched capacitor C1A and switch SW1A are electrically coupled to both the inverting input terminal and output terminal of the differential amplifier A1 to form a closed loop, and the switched capacitor C1B and switch SW1B are electrically coupled to both the inverting input terminal and output terminal of the differential amplifier A2 to form another closed loop. The first electrode 101PE of the capacitor C_{DUT} is electrically coupled to the inverting input terminal of the differential amplifier A1 and the second electrode 102RE of the capacitor C_{DUT} is coupled to the inverting input terminal of the differential amplifier A2. A modulated voltage VA is electrically coupled to the non-inverting input terminal of the differential amplifier A1, and a modulated voltage VB is electrically coupled to the non-inverting input terminal of the differential amplifier A2. The fully differential output voltage VOUT is the voltage difference between the output voltage of the differential amplifier A1 (VOUT1), and the output voltage of the differential amplifier A2 (VOUT2). By modulating the voltages of VA and VB, controlling the switches, SW1A and SW1B, and measuring the output voltage VOUT of the sensing circuit, the capacitance C_{DUT} can be evaluated.

FIG. 12A shows the control signal waveforms of the switches SW1A and SW1B and the modulated voltages waveforms of VA and VB (in the capacitance sensing function element schematic circuit 116MS4 shown of FIG. 12). Two phases are required for sensing the capacitance under test capacitor C_{DUT}, wherein are reset phase and sensing phase. During the reset phase, the switches, SW1A and SW1B, are turned on, and both the voltages of VA and VB are V1. During the sensing phase, the switches, SW1A and SW1B, are turned off. The voltages of VA and VB are modulated. The voltage VA is modulated to V1+ΔV from V1, and the voltage of VB is modulated to V1−ΔV from V1. The operation of the fully differential sensing circuit is similar to that of the sensing circuit of FIG. 9. The output voltages, VOUT1 and VOUT2, of the differential amplifier amplifiers, A1 and A2, can be obtained accordingly and are expressed as:

$${V}_{o u t 1} = {V}_{1} + ΔV + 2 \frac{ΔV}{{C}_{1 A}} {C}_{DUT} \qquad ( 16 A )$$

$${V}_{o u t 2} = {V}_{1} - ΔV - 2 \frac{ΔV}{{C}_{1 B}} {C}_{DUT} \qquad ( 16 B )$$

By setting the values of C1A and C1B to be the same and to be C1, the fully differential output voltage V_{OUT} (Vₒᵤₜ₁−Vₒᵤₜ₂) can be expressed as:

$${V}_{o u t} = 2 ΔV + 4 \frac{ΔV}{{C}_{1}} {C}_{DUT} \qquad ( 17 )$$

where the term of 2ΔV is a dc offset voltage, and the gain of the sensing circuit is 4ΔV/C1. The capacitance C_{DUT} can be evaluated from the output voltage V_{OUT}. From Equation (17), the expression of the capacitance C_{DUT} can be expressed as:

$${C}_{DUT} = ( {V}_{OUT} - 2 ΔV ) \frac{{C}_{1}}{4 ΔV} \qquad ( 18 )$$

Therefore, setting an appropriate value for C1, and applying appropriate values of V1 and ΔV, the capacitance C_{DUT} can be measured and evaluated according to the Equation (18).

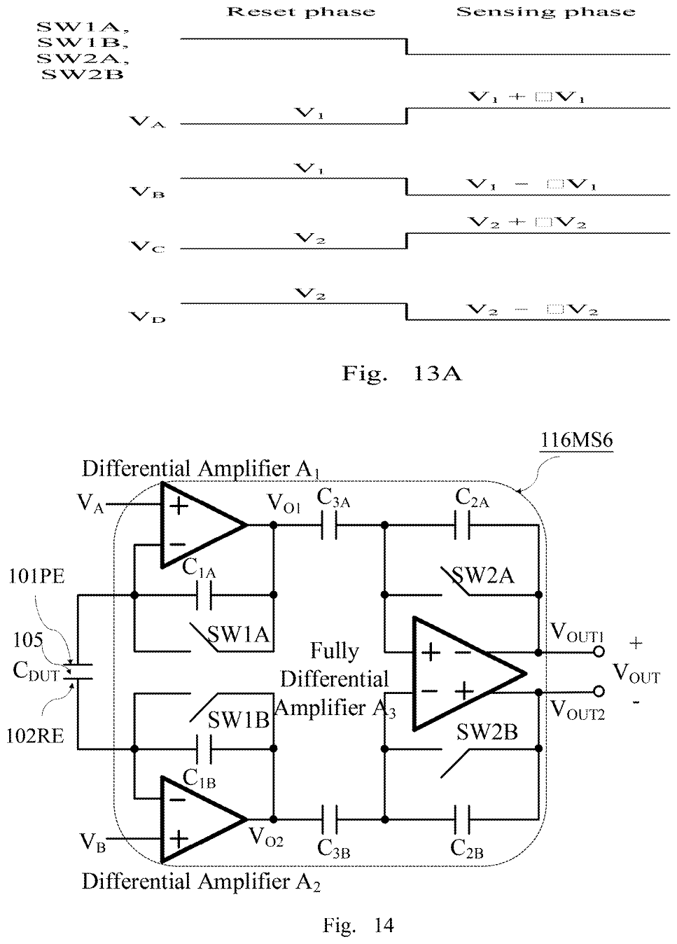

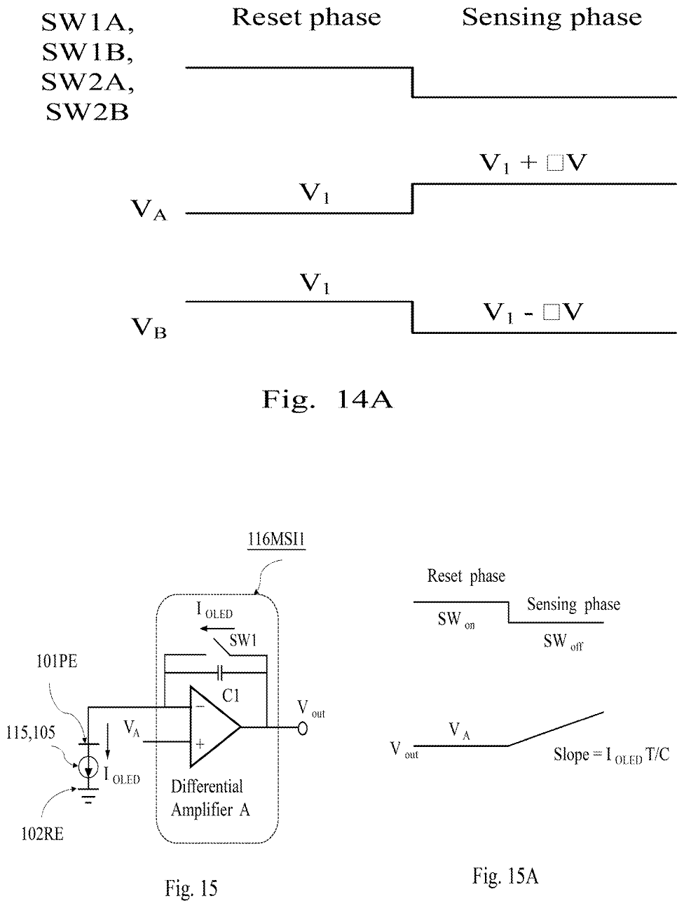

To increase the sensitivity and noise-signal ratio of the capacitance sensing function element schematic circuit 116MS4 in FIG. 12, a sensing function element schematic circuit 116MS5 can be modified to a two-stage fully differential capacitance sensing circuit as shown in FIG. 13. The sensing function element schematic circuit 116MS5 is a capacitor measurement schematic circuit (Device Under Test: C_{DUT}/display medium 105), such as the liquid crystal disposed between the first electrode 101PE and the second electrode 102RE of the display medium 105, wherein comprise four differential amplifiers A1, A2, A3, and A4 and four switches SW1A, SW1B, SW2A, and SW2B, are constructed from the transistors 116T of the active switching element 116; four switched capacitors C1A, C1B, C2A, C2B, and two coupling capacitors C3A and C3B. The first-stage sensing circuit comprises two differential amplifiers A1 and A2, two switches SW1A and SW1B, and two switched capacitors C1A and C1B. For the first-stage sensing circuit, the switched capacitor CIA and switch SW1A are electrically coupled to both the inverting input terminal and output of the differential amplifier A1 to form a closed loop, and the switched capacitor C1B and switch SW1B are electrically coupled to both the inverting input terminal and output of the differential amplifier A2 to form another closed loop. The first electrode 101PE of the capacitor C_{DUT} is electrically coupled to the inverting input terminal of the differential amplifier A1 and the second electrode 102RE of the capacitor C_{DUT} is electrically coupled to the inverting input terminal of the differential amplifier A2. A modulated voltage VA is electrically coupled to the non-inverting input terminal of the differential amplifier A1, and a modulated voltage VB is electrically coupled to the non-inverting input terminal of the differential amplifier A2. The second-stage sensing circuit comprises two differential amplifiers A3 and A4; two switches SW2A and SW2B; and two switched capacitors C2A and C2B. For the second-stage sensing circuit, the switched capacitor C2A and switch SW2A are electrically coupled to both the inverting input terminal and output of the differential amplifier A3 to form a closed loop. A modulated voltage VC is electrically coupled to the non-inverting input terminal of the differential amplifier A3. The switched capacitor C2B and switch SW2B are electrically coupled to both the inverting input terminal and output of the differential amplifier A4 to form a closed loop. A modulated voltage VD is electrically coupled to the non-inverting input terminal of the differential amplifier A4. Two coupling capacitors C3A and C3B are electrically coupled between the output terminals of the first-stage sensing circuit and the input terminals of the second-stage sensing circuit. A coupling capacitor C3A is electrically coupled to the output VO1 of the differential amplifier A1 and the inverting input terminal of the differential amplifier A3. Another coupling capacitor C3B is electrically coupled to the output VO2 of the differential amplifier A2 and the inverting input terminal of the differential amplifier A4. The fully differential output voltage VOUT is the voltage difference between the output voltage VOUT1 of the differential amplifier A3 and the output voltage VOUT2 of the differential amplifier A4. By modulating the voltages of VA, VB, VC, and VD, controlling the switches, SW1A, SW1B, SW2A, and SW2B, and measuring the output voltage VOUT of the sensing circuit, the capacitance C_{DUT} can be evaluated.

FIG. 13A shows the control signal waveforms of the switches SW1A, SW1B, SW2A and SW2B and the modulated voltages waveforms of VA, VB, VC, and VD (in the capacitance sensing function element schematic circuit 116MS5 of FIG. 13). Two phases are required for sensing the capacitance under test capacitor C_{DUT}, wherein are reset phase and sensing phase. During the reset phase, the switches, SW1A, SW1B, SW2A, and SW2B are turned on, and the voltages of VA and VB modulated to V1, and the voltages of VC and VD modulated to V2. During the sensing phase, the switches, SW1A, SW1B, SW2A, and SW2B, are turned off, meantime the voltages of VA, VB, VC, and VD are modulated. The voltage VA is modulated to V1+ΔV from V1, the voltage of VB is modulated to V1−ΔV from V1, The voltage VC is modulated to V2+ΔV from V2, and the voltage of VD is modulated to V2−ΔV from V2. The operation of the fully differential sensing schematic circuit is similar to that of the sensing circuit of FIG. 12. To achieve the fully differential operation, the values of switched capacitor C1A and C1B are designed to be identical and to be C1, the values of switched capacitor C2A and C2B are C2, the values of switched capacitor C3A and C3B are C3. The output voltages, V_{O1} and V_{O2}, of the differential amplifier amplifiers A1 and A2, can be obtained accordingly and are expressed as:

$${V}_{O 1} = {V}_{1} + Δ {V}_{1} + 2 \frac{Δ V 1}{{C}_{1}} {C}_{DUT} \qquad ( 19 A )$$

$${V}_{O 2} = {V}_{1} - Δ {V}_{1} - 2 \frac{Δ V 1}{{C}_{1}} {C}_{DUT} \qquad ( 19 B )$$

The operation of the second-stage switched-capacitor circuit of the capacitance sensing schematic circuit is similar to the operation of the capacitance sensing schematic circuit 116MS2 as shown in FIG. 10. By the same procedure of finding the output voltage of the second-stage switched-capacitor circuit of the capacitance sensing schematic circuit 116MS2 shown in FIG. 10, the output voltage V_{OUT1} of the differential amplifier A3 can be found and expressed as:

$${V}_{OUT 1} = {V}_{2} + Δ {V}_{2} + ( Δ {V}_{2} - Δ {V}_{1} ) \frac{{C}_{3}}{{C}_{2}} - 2 \frac{{C}_{3}}{{C}_{2}} \frac{Δ {V}_{1}}{{C}_{1}} {C}_{DUT} \qquad ( 20 A )$$

Similarly, the output voltage V_{OUT2} of the differential amplifier A4 can be found and expressed as:

$${V}_{OUT 2} = {V}_{2} - {ΔV}_{2} - ( {ΔV}_{2} - Δ {V}_{1} ) \frac{{C}_{3}}{{C}_{2}} + 2 \frac{{C}_{3}}{{C}_{2}} \frac{Δ {V}_{1}}{{C}_{1}} {C}_{DUT} \qquad ( 20 B )$$

From Equations (20A) and (20B), the output voltage V_{OUT} of the sensing circuit can be obtained as:

$${V}_{OUT} = 2 Δ {V}_{2} + 2 ( Δ {V}_{2} - Δ {V}_{1} ) \frac{{C}_{3}}{{C}_{2}} - 4 \frac{{C}_{3}}{{C}_{2}} \frac{Δ {V}_{1}}{{C}_{1}} {C}_{DUT} \qquad ( 21 )$$

where the term of

$$2 Δ {V}_{2} + 2 ( Δ {V}_{2} - Δ {V}_{1} ) \frac{{C}_{3}}{{C}_{2}}$$

is a dc voltage, and the gain of the sensing circuit is

$$- 4 \frac{{C}_{3}}{{C}_{2}} \frac{Δ {V}_{1}}{{C}_{1}} .$$

the capacitance of the measured-capacitor C_{DUT} can be evaluated from the output voltage V_{OUT}. From Equation (21), the expression of the capacitance C_{DUT} can be expressed as:

$${C}_{DUT} = \frac{1}{4} [ 2 Δ {V}_{2} + 2 ( Δ {V}_{2} - Δ {V}_{1} ) \frac{{C}_{3}}{{C}_{2}} - {V}_{OUT} ] \frac{{C}_{2}}{{C}_{3}} \frac{{C}_{1}}{Δ {V}_{1}} \qquad ( 22 )$$

Therefore, setting an appropriate value for C1, C2, and C3, and applying appropriate values of V1, V2, and ΔV1, and ΔV2, the capacitance of the capacitor under test can be measured and evaluated according to the Equation (22).

The differential amplifiers A3 and A4 of the capacitance sensing schematic circuit 116MS5 shown in FIG. 13 can be combined as a two-stage fully differential amplifier as shown in FIG. 14. The sensing function element schematic circuit 116MS6 is a capacitor measurement schematic circuit (Device Under Test: C_{DUT}/display medium 105), such as the liquid crystal disposed between the first electrode 101PE and the second electrode 102RE of the display medium 105, wherein comprise two differential amplifiers A1 and A2, a fully differential amplifier A3 and four switches SW1A, SW1B, SW2A, and SW2B, are constructed from the transistors 116T of the active switching element 116; four switched capacitors C1A, C1B, C2A, and C2B; and two coupling capacitors C3A and C3B. The first-stage sensing circuit comprises two differential amplifiers A1 and A2; two switches SW1A and SW1B; and two switched capacitors C1A and C1B. For the first-stage sensing circuit, the switched capacitor CIA and switch SW1A are electrically coupled to both the inverting input terminal and output of the differential amplifier A1 to form a closed loop, and the switched capacitor C1B and switch SW1B are electrically coupled to both the inverting input terminal and output of the differential amplifier A2 to form another closed loop. The first electrode 101PE of the capacitance C_{DUT} (display medium 105) electrically coupled to the inverting input terminal of the differential amplifier A1 and the second electrode 102RE of the capacitance C_{DUT} electrically coupled to the inverting input terminal of the differential amplifier A2. A modulated voltage VA is electrically coupled to the non-inverting input terminal of the differential amplifier A1, and a modulated voltage VB is electrically coupled to the non-inverting input terminal of the differential amplifier A2. The second-stage sensing circuit comprises a fully differential amplifier A3; two switched capacitors C2A and C2B; and two switches SW2A and SW2B. For the second-stage sensing circuit, the capacitor C2A and switch SW2A are electrically coupled to both the non-inverting input terminal and inverting output terminal of the fully differential amplifier A3 to form a closed loop. The capacitor C2B and switch SW2B are electrically coupled to both the inverting input terminal and non-inverting output terminal of the fully differential amplifier A3 to form another closed loop. The switched capacitor C2B and switch SW2B are electrically coupled to both the inverting input terminal and non-inverting output terminal of the fully differential amplifier A3 to form another closed loop. A common-mode feedback circuit is required for the fully differential amplifier A3 to control the output common-mode voltage. Two coupling capacitors C3A and C3B are electrically coupled between the output terminals of the first-stage sensing circuit and the input terminals of the second-stage sensing circuit. That is: the coupling capacitor C3A is electrically coupled to the output VO1 of the differential amplifier A1 and the non-inverting input terminal of the fully differential amplifier A3, and the coupling capacitor C3B is electrically coupled to the output V_{O2} of the differential amplifier A2 and the inverting input terminal of the fully differential amplifier A3. The voltage at the inverting output terminal of the fully differential amplifier A3 is indicated as V_{OUT1}, and the voltage at the non-inverting output terminal of the fully differential amplifier A3 is indicated as V_{OUT2}. The fully differential output voltage VOUT is the voltage difference between the output voltage V_{OUT1} and the output voltage V_{OUT2}. By modulating the voltages of VA and VB, controlling the switches, SW1A, SW1B, SW2A, and SW2B, and measuring the output voltage V_{OUT} of the sensing circuit, the capacitance C_{DUT} can be evaluated.

FIG. 14A shows the control signal waveforms of the switches SW1A, SW1B, SW2A and SW2B, and the modulated voltages waveforms of VA and VB (in the sensing function element circuit schematic 116MS6 of FIG. 14). Two phases are required for sensing the capacitance of the device under test capacitor C_{DUT}, wherein are reset phase and sensing phase. During the reset phase, the switches SW1A, SW1B, SW2A, and SW2B are turned on, and the voltages of VA and VB modulated to V1. During the sensing phase the switches, SW1A, SW1B, SW2A, and SW2B, are turned off, meantime the voltages of VA and VB are modulated. The voltage VA is modulated to V1+ΔV from V1, the voltage of VB is modulated to V1−ΔV from V1. The operation of the first-stage sensing circuit is the same as the operation of the first-stage sensing circuit of FIG. 13. To achieve the fully differential operation, the values of the switched capacitors C1A and C1B are designed to be identical and to be C1, the values of the switched capacitors C2A and C2B are C2, the values of the coupling capacitors C3A and C3B are C3. The output voltages, V_{O1} and V_{O2}, of the differential amplifier amplifiers, A1 and A2, can be obtained accordingly and are expressed as:

$${V}_{O 1} = {V}_{1} + Δ {V}_{1} + 2 \frac{Δ V 1}{{C}_{1}} {C}_{DUT} \qquad ( 23 A )$$

$${V}_{O 2} = {V}_{1} - Δ {V}_{1} - 2 \frac{Δ V 1}{{C}_{1}} {C}_{DUT} \qquad ( 23 B )$$

The output voltages, V_{OUT1} and V_{OUT2}, of the second-stage sensing circuit can also be obtained by using the charge conservation. Because of the closed loops formed by the switches SW2A and SW2B, and the two switched capacitors C2A and C2B, the voltages at the inverting input terminal and the non-inverting input terminal of the fully differential amplifier A3 are the common-mode voltage V_{COM} during both the reset and sensing phases. Because of the conservation of charge, wherein the total charge of C2A and C3A should be the same, and the total charge of C2B and C3B should be the same during the reset phase and sensing phase. The equations of the charge conservation can be expressed as:

$$( {V}_{C O M} - {V}_{OUT 1} ) {C}_{2} + ( {V}_{C O M} - {V}_{O 1} ) {C}_{3} = ( {V}_{C O M} - {V}_{1} ) {C}_{3} \qquad ( 24 A )$$

$$( {V}_{C O M} - {V}_{OUT 2} ) {C}_{2} + ( {V}_{C O M} - {V}_{O 2} ) {C}_{3} = ( {V}_{C O M} - {V}_{1} ) {C}_{3} \qquad ( 24 B )$$

From Equations (23A), (24A), (23B) and (24B), the output voltages V_{OUT1} and V_{OUT2} of the sensing circuit can be obtained as:

$${V}_{OUT 1} = {V}_{C O M} - Δ V ( 1 + 2 \frac{{C}_{DUT}}{{C}_{1}} ) \frac{{C}_{3}}{{C}_{2}} \qquad ( 25 A )$$

$${V}_{OUT 2} = {V}_{C O M} + Δ V ( 1 + 2 \frac{{C}_{DUT}}{{C}_{1}} ) \frac{{C}_{3}}{{C}_{2}} \qquad ( 25 B )$$

From Equations (25A) and (25B), the output voltage V_{OUT} of the sensing circuit can be obtained as:

$${V}_{OUT} = - 2 Δ V \frac{{C}_{3}}{{C}_{2}} - 4 Δ V \frac{{C}_{3}}{{C}_{2}} \frac{{C}_{DUT}}{{C}_{1}} \qquad ( 26 )$$

where the term of

$$- 2 Δ V \frac{{C}_{3}}{{C}_{2}}$$

is a dc offset voltage, and the gain of the sensing circuit is

$$- 4 \frac{{C}_{3}}{{C}_{2}} \frac{Δ V}{{C}_{1}} .$$

The gain of the sensing circuit can be increased by increasing the capacitance ratio of C3 and C2. The capacitance of the capacitor under test C_{DUT} can be evaluated from the output voltage VOUT. From Equation (26), the expression of the capacitance of the capacitor under test C_{DUT} can be expressed as:

$${C}_{DUT} = - \frac{{C}_{1}}{4 Δ V} \frac{{C}_{2}}{{C}_{3}} {V}_{OUT} - \frac{{C}_{1}}{2} \qquad ( 27 )$$

Therefore, setting an appropriate value for C1, C2, and C3 and applying appropriate values of V1 and ΔV, the capacitance C_{DUT} can be measured and evaluated according to the Equation (27).

FIG. 15 is a sensing function element schematic circuit 116MSI1 for sensing, measuring and/or compensating the characteristics of the display medium 115 or 105 of the present invention, such as, refer to FIG. 4A to 4B. The sensing function element schematic circuit 116MSI1 is a current-Voltage (I-V) measurement schematic circuit comprise a differential amplifier A and a switch SW1, are constructed from the transistors 116T of the active switching element 116; a switched capacitor C1, and one or more display medium materials. The display medium materials may include electroluminescent material, photoluminescent material, cathodoluminescent material, field emissive luminescent material, phosphorescent material, quantum dot material, fluorescent material, organic light-emitting diode and light-emitting diode and so on. Wherein, using the organic light-emitting diode (OLED) materials disposed between the first electrode 101PE and the second electrode 102RE of the display medium module as the sample shown in FIG. 15 (no only limited OLED). The switched capacitor C1 and switch SW1 are electrically coupled to both the inverting input terminal and output terminal of the differential amplifier A to form a closed loop. The first electrode 101PE (anode electrode) of the display medium module is electrically coupled to the inverting input terminal of the differential amplifier A. The second electrode 102RE (cathode electrode) of the display medium module is connected to ground (shown in FIG. 4B) or a dc voltage (no shown in FIGS). A modulated voltage VA is electrically coupled to the non-inverting input terminal of the differential amplifier A. By modulating the voltage VA, controlling the switch SW1, and measuring the output voltage of the differential amplifier A, the I-V characteristics of the OLED display medium (I_{OLED}) can be evaluated.

FIG. 15A shows a control signal waveform of the switch SW1 and a modulated voltages VA waveform of the differential amplifier A (in the sensing function element schematic circuit 116MSI1 shown of FIG. 15). The sensing operation is divided into two phases: reset phase and sensing phase. During the reset phase, the switch SW1 is turned on. The differential amplifier A is connected as a unity-gain amplifier by the switch SW1, and the anode voltage of the pixel OLED under test is forced to be VA. The voltage across the pixel OLED is then VA−GND. The output voltage of the differential amplifier A is also V_{OUT}. During the sensing phase, the switch SW1 is turned off. Because of the closed loop of the differential amplifier A and the capacitor C1, the anode voltage of the OLED under test is kept to be VA. The OLED current I_{OLED} flows through the capacitor C1. The output voltage of the differential amplifier A increases from the voltage of VA during the sensing phase. The output voltage, V_{OUT}, of the differential amplifier A can be expressed as:

$${V}_{OUT} = {V}_{A} + \frac{1}{C} {\int }_{0}^{T} {I}_{O L E D} d t \qquad ( 28 )$$

If the output voltage V_{OUT} is measured at the time T, the output voltage V_{OUT} can be expressed as:

$${V}_{OUT} = {V}_{A} + \frac{1}{C} {I}_{OLED} T \qquad ( 29 )$$

According to Equation (29), the OLED characteristic (I-V curve) I_{OLED} can be obtained by applying different voltage difference (VA−GND) and measuring the output voltage V_{OUT} of the differential amplifier A.

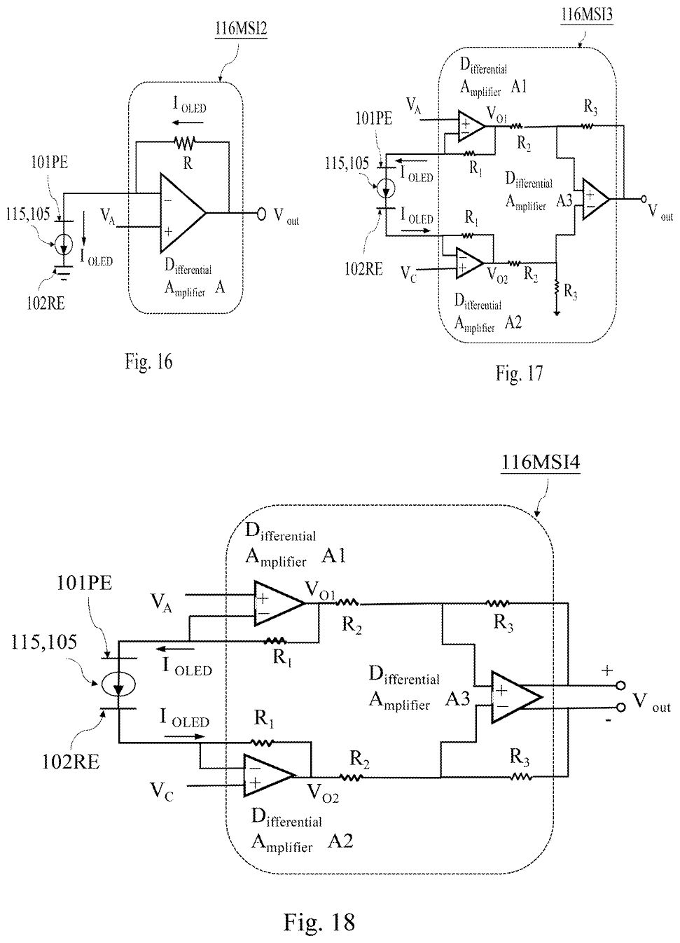

FIG. 16 is a sensing function element schematic circuit 116MSI2 for sensing and measuring the characteristics of the display medium 115 or 105 of the present invention, such as, refer to FIG. 4A to 4B. The sensing function element schematic circuit 116MSI2 is a I-V measurement schematic circuit comprise a differential amplifier A, constructed from the transistors 116T of the active switching element 116; a resistor R; and a display medium materials, wherein include at least one of electroluminescent material, photoluminescent material, cathodoluminescent material, field emissive luminescent material, phosphorescent material, quantum dot material, fluorescent material, organic light-emitting diode and light-emitting diode and so on. Wherein, using the organic light-emitting diode (OLED) materials disposed between the first electrode 101PE and the second electrode 102RE of the display medium module (no only limited OLED). The resistor R is electrically coupled to both the inverting input terminal and output terminal of the differential amplifier A to form a closed loop. The first electrode 101PE (anode electrode) of the display medium module is electrically coupled to the inverting input terminal of the differential amplifier A. The second electrode 102RE (cathode electrode) of the display medium module is electrically connected to ground (shown in FIG. 16) or a dc voltage (no shown in FIG.). A modulated voltage VA is electrically coupled to the non-inverting input terminal of the differential amplifier A. The negative feedback loop formed by the differential amplifier A and the resistor R forces the anode voltage of the pixel OLED under test to be VA. The voltage across the pixel OLED is then VA−GND. The current I_{OLED} flows through the resistors R. The output voltage of the differential amplifier A is denoted as V_{OUT}. The relationship between the pixel OLED current I_{OLED} and the output voltage V_{OUT} of the differential amplifier A can be expressed as:

$${V}_{OUT} = {I}_{OLED} R + {V}_{A} \qquad ( 30 )$$

The pixel OLED current then can be expressed as:

$${I}_{OLED} = \frac{1}{R} ( {V}_{OUT} - {V}_{A} ) \qquad ( 31 )$$

According to Equation (31), the OLED characteristic (I-V curve) I_{OLED} can be obtained by applying different voltage difference (VA−GND) and measuring the output voltage V_{OUT}.

To increase the common-mode rejection ratio (CMRR), two extra differential amplifiers are added in the sensing circuit FIG. 17. The sensing function element schematic circuit 116MSI3 is for sensing, measuring and/or compensating the characteristics of the display medium 115 or 105 of the present invention. The sensing function element schematic circuit 116MSI3 is a I-V measurement schematic circuit, comprise three differential amplifiers A1, A2 and A3 are constructed from the transistors 116T of the active switching element 116; three pairs of resistors R1, R2 and R3; and one more display medium, wherein include electroluminescent material, photoluminescent material, cathodoluminescent material, field emissive luminescent material, phosphorescent material, quantum dot material, fluorescent material, organic light-emitting diode and light-emitting diode and so on. Wherein, the organic light-emitting diode (OLED) materials disposed between the first electrode 101PE and the second electrode 102RE of the display medium module (no only limited OLED). Wherein, three differential amplifiers A1, A2 and A3 are constructed from the transistors 116T of the active switching element 116, and three pairs of resistors R1, R2 and R3 can measure the OLED I-V characteristic. The inverting input terminal of the differential amplifiers A2 is electrically coupled to the cathode electrode (102RE) of the pixel OLED. The inverting input terminal of the differential amplifiers A1 is electrically coupled to the anode electrode (101PE) of the pixel OLED. The voltages of VA and VC are two reference voltages. Two closed loops of the differential amplifiers A1 and A2 with a pair of resistors R1 force the anode voltage of the pixel OLED under test to be VA and the cathode voltage to be VC. The voltage across the pixel OLED is then VA−VC. The current I_{OLED} flows through the pair of resistors R1. The output voltages of the differential amplifiers A1 and A2 are denoted as V_{O1} and V_{O2}, respectively. The relationship between the pixel OLED current I_{OLED} and the voltage difference between VO1 and VO2 can be expressed as:

$${V}_{O 1} - {V}_{O 2} = 2 {I}_{OLED} {R}_{1} + ( {V}_{A} - {V}_{C} ) \qquad ( 32 )$$

The differential amplifier A3 and two pairs of resistors R₂ and R₃ form a difference amplifier. The output voltage V_{OUT} can be expressed as

$${V}_{OUT} = \frac{{R}_{3}}{{R}_{2}} ( {V}_{O 2} - {V}_{O 1} ) \qquad ( 33 )$$

The relationship between the output voltage V_{OUT} and the OLED current I_{LED} can then be expressed as:

$${V}_{OUT} = \frac{{R}_{3}}{{R}_{2}} [ 2 {I}_{OLED} {R}_{1} + ( {V}_{A} - {V}_{C} ) ] \qquad ( 34 )$$

From Equation (57), the OLED current can be expressed as:

$${I}_{OLED} = \frac{{R}_{2}}{2 {R}_{1} {R}_{3}} {V}_{OUT} - \frac{{V}_{A} - {V}_{C}}{2 {R}_{1}} \qquad ( 35 )$$

According to Equation (35), the OLED characteristic (I-V curve) I_{OLED} can be obtained by setting R1, R2 and R3, applying different voltage difference (V_{A}−V_{C}) and measuring the output voltage V_{OUT}.

Some analog-to-digital converters convert the differential voltage to digital data. In order to output a differential voltage, the sensing circuit schematic circuit 116MSI3 can be modified to a sensing circuit with a differential output voltage. FIG. 18, a sensing function element schematic circuit 116MSI4 for sensing and measuring the characteristics of the display medium 115 or 105 of the present invention. The sensing function element schematic circuit 116MSI4 is a I-V measurement schematic circuit, such as Self-luminous medium materials may include at least one of electroluminescent material, photoluminescent material, cathodoluminescent material, field emissive luminescent material, phosphorescent material, quantum dot material, fluorescent material, organic light-emitting diode and light-emitting diode and so on. Wherein, the organic light-emitting diode (OLED) materials disposed between the first electrode 101PE and the second electrode 102RE of the display medium module, and wherein two differential amplifiers with single-ended output A1 and A2 and a fully differential amplifier A3 are constructed from the transistors 116T of the active switching element 116; and three pairs of resistors R1, R2 and R3 can measure the OLED I-V characteristic. The inverting input terminal of the differential amplifiers A2 is electrically coupled to the cathode electrode (102RE) of the pixel OLED. The inverting input terminal of the differential amplifiers A1 is electrically coupled to the anode electrode (101PE) of the pixel OLED. The voltages of VA and VC are two reference voltages. Two closed loops of differential amplifiers A1 and A2 with a pair of resistors R1 force the anode electrode voltage of the pixel OLED under test to be VA and the cathode electrode voltage to be VC. The voltage across the pixel OLED is then VA−VC. The current I_{OLED} flows through the pair of resistors R1. The output voltages of the differential amplifiers A1 and A2 are denoted as V_{O1} and V_{O2}, respectively. The relationship between the pixel OLED current I_{OLED} and the voltage difference between VO1 and VO2 can be expressed as:

$${V}_{O 1} - {V}_{O 2} = 2 {I}_{OLED} {R}_{1} + ( {V}_{A} - {V}_{C} ) \qquad ( 36 )$$

The fully differential amplifier A3 and two pairs of resistors R2 and R3 form a difference amplifier. The differential output voltage VOUT can be expressed as:

$${V}_{OUT} = \frac{{R}_{3}}{{R}_{2}} ( {V}_{O 2} - {V}_{O 1} ) \qquad ( 37 )$$

The relationship between the differential output voltage V_{OUT} and the OLED current I_{OLED} can then be expressed as:

$${V}_{OUT} = \frac{{R}_{3}}{{R}_{2}} [ 2 {I}_{OLED} {R}_{1} + ( {V}_{A} - {V}_{C} ) ] \qquad ( 38 )$$

From Equation (38), the OLED current can be expressed as:

$${I}_{OLED} = \frac{{R}_{2}}{2 {R}_{1} {R}_{3}} {V}_{OUT} - \frac{{V}_{A} - {V}_{C}}{2 {R}_{1}} \qquad ( 39 )$$

According to Equation (39), the LED characteristic (I-V curve) can be obtained by applying different voltage difference (VA−VC) and measuring the differential output voltage V_{OUT}.

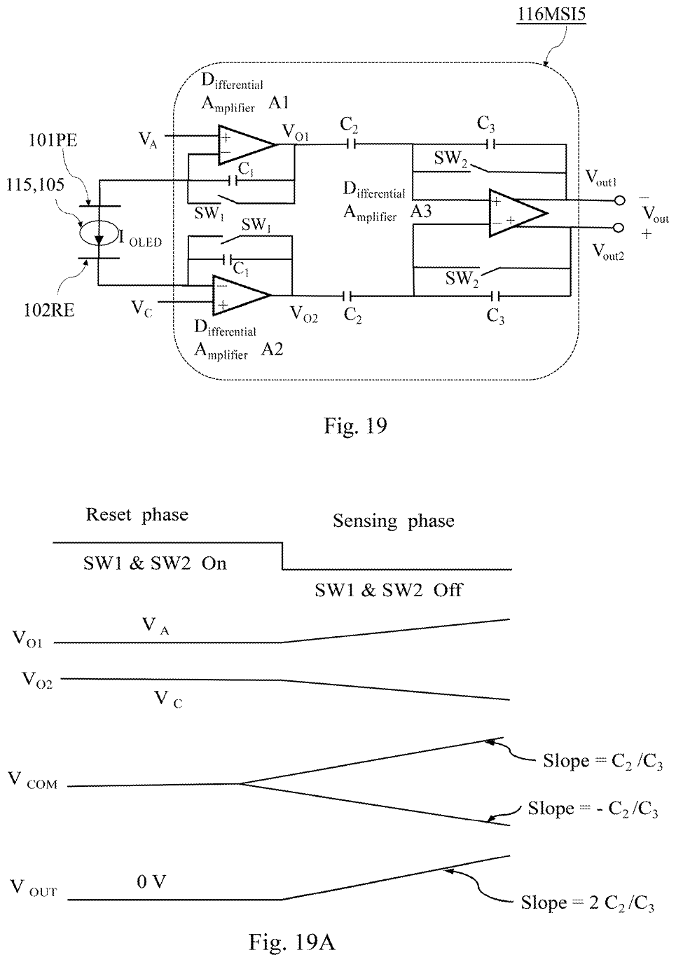

The sensing circuit schematic circuit 116MSI4 can be modified to a switched-capacitor version. FIG. 19 is a schematic of the switched-capacitor sensing circuit with differential outputs with a sensing function element schematic circuit 116MSI5. The sensing function element schematic circuit 116MSI5 for sensing and measuring the characteristics of the display medium 115 or 105 of the present invention. The sensing function element schematic circuit 116MSI5 is a I-V measurement schematic circuit, such as Self-luminous medium materials may include at least one of electroluminescent material, photoluminescent material, cathodoluminescent material, field emissive luminescent material, phosphorescent material, quantum dot material, fluorescent material, organic light-emitting diode and light-emitting diode and so on. Wherein, the organic light-emitting diode (OLED) materials disposed between the first electrode 101PE and the second electrode 102RE of the display medium module. The sensing circuit 116MSI5, wherein comprises t two differential amplifiers with single-ended output A1 and A2; a fully differential amplifier A3 and two pairs of switches SW1 and SW2 are constructed from the transistors 116T of the active switching element 116, and three pairs of capacitors C1, C2 and C3 can measure the OLED I-V characteristic.

The inverting input terminal of the differential amplifiers A2 is electrically coupled to the cathode electrode (102RE) of the pixel OLED. The inverting input terminal of the differential amplifiers A1 is electrically coupled to the anode electrode (101PE) of the pixel OLED. The voltages of VA and VC are two reference voltages. The sensing operation is divided into two phases: reset phase and sensing phase. FIG. 19A is the voltage operation waveform of the sensing circuit schematic circuit 116MSI5. During the reset phase, the switches SW1 and SW2 are turned on. The differential amplifiers A1 and A2 form a unity-gain amplifier, and the anode electrode (101PE) voltage and the cathode electrode (102RE) voltage of the pixel OLED under test are forced to be VA and VC, respectively. The voltage across the pixel OLED is then VA−VC. The output voltages V_{O1} and V_{O2} are VA and VC, respectively. The output voltages (V_{OUT1} and V_{OUT2}) of the fully differential amplifier A3 are the common-mode voltage VCOM during the reset phase. The common-mode voltage VCOM is controlled by a common-mode feedback circuit. The differential output voltage VOUT is the difference between V_{OUT2} and V_{OUT1}. During the sensing phase, the switches SW1 and SW2 are turned off. Because of the closed loops of the differential amplifiers A1 and A2 and the capacitor C1, the voltage across the anode electrode and cathode electrode of the OLED under test is kept to be (VA−VC). The OLED current I_{OLED} flows through the two capacitors C1. The output voltages, V_{O1} and V_{O2}, of A1 and A2 can be expressed as:

$${V}_{O 1} = {V}_{A} + \frac{1}{{C}_{1}} {\int }_{0}^{T} {I}_{OLED} dt \qquad ( 40 )$$

$${V}_{O 2} = {V}_{C} - \frac{1}{{C}_{1}} {\int }_{0}^{T} {I}_{OLED} dt \qquad ( 41 )$$

The output voltage V_{O1} is increased from the reference voltage VA, and the output voltage V_{O2} is decreased from the reference voltage VC. These two voltages, V_{O1} and V_{O2}, are electrically coupled to the non-inverting input terminal and the inverting input terminal of A3, respectively, by a pair of capacitors C2. Because of the closed loop of the fully differential amplifier A3 with a pair of capacitors C3, the non-inverting input terminal voltage and the inverting input terminal voltage of A3 are kept to be the common-mode voltage VCOM, and the charges of the pair of capacitors C2 are transferred to the pair of capacitors C3. The output voltage V_{OUT1} of A3 is then decreased from the common-mode voltage VCOM with a slope of —C2/C3, and the output voltage V_{OUT2} of A3 is then increased from the common-mode voltage VCOM with a slope of C2/C3. The output voltages V_{OUT1} and V_{OUT2} can be expressed as:

$${V}_{OUT 1} = {V}_{COM} - \frac{{C}_{2}}{{C}_{1} {C}_{3}} {\int }_{0}^{T} {I}_{OLED} dt \qquad ( 42 )$$

$${V}_{OUT 2} = {V}_{COM} + \frac{{C}_{2}}{{C}_{1} {C}_{3}} {\int }_{0}^{T} {I}_{OLED} dt \qquad ( 43 )$$

The differential output voltage V_{OUT} then can be obtained as:

$$\begin{matrix}{V}_{OUT} = {V}_{OUT 2} - {V}_{OUT 1}\end{matrix} \qquad ( 44 )$$

$$\begin{matrix}= \frac{2 {C}_{2}}{{C}_{1} {C}_{3}} {\int }_{0}^{T} {I}_{OLED} dt\end{matrix} \qquad ( 45 )$$

If the output voltage V_{OUT} is measured at the time T, the output voltage V_{OUT} can be expressed as:

$${V}_{OUT} = \frac{2 {C}_{2}}{{C}_{1} {C}_{3}} {I}_{OLED} T \qquad ( 46 )$$

According to Equation (46), the OLED characteristic (I-V curve) I_{OLED} can be obtained by applying different voltage difference (VA−VC) and measuring the differential output voltage VOUT.

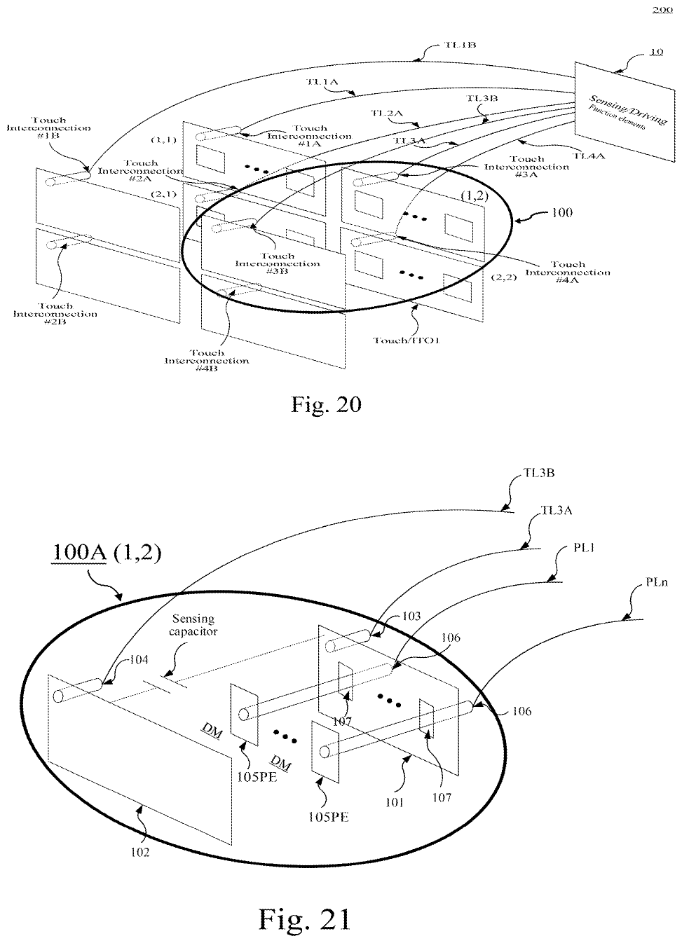

The magnitude of capacitance, which is inversely proportional to the distance of one electrode pair (distance between the upper and lower electrodes). Therefore, the electrodes of the display can be used for touch sensing device by detect the capacitance variation between those electrode pairs for detecting the touch location. FIG. 20 is a diagram of a touch electronic display apparatus 200 of an embodiment of the present invention for sensing capacitances of the touch and display devices 100. The touch electronic display apparatus 200 comprise a plurality of touch and display devices 100, a plurality of touch interconnection lines TL1A˜TL4A and TL1B˜TL4B electrically coupled to the touch and display devices 100, a sensing and driving function element 10 constructed from the transistors 116T of the active switching element 116 for sensing and driving the characteristics of the display and touch devices 100, thereof through electrically coupled to the touch interconnection lines TL1A˜TL4A and TL1B˜TL4B for sensing the capacitance of the touch/display devices 100.

FIG. 21 is a diagram of the touch and display device 100A showing that the touch and display device 100A comprises a first electrode 101, a second electrode 102, a first touch interconnection 103 electrically coupled to the first electrode 101, a second touch interconnection 104 electrically coupled to the second electrode 102, a first touch interconnection line TL3A electrically coupled to the first touch interconnection 103, a second touch interconnection line TL3B electrically coupled to the touch interconnection 104, a plurality of display electrodes 105PE, a display mediums DM, a plurality of display interconnections 106 electrically coupled to the display electrodes 105PE, a plurality of opening holes 107, and a plurality of display interconnection lines PL1˜PLn electrically coupled to the display interconnections 106. The first electrode 101 and the second electrode 102 form a sensing capacitor. The capacitance of the sensing capacitor can be detected by the sensing and driving function element 10 (no shown; same as FIG. 20) through the first touch interconnection line TL3A and the second touch interconnection line TL3B. The display medium DM is disposed between the display electrode 105PE and the second electrode 102. The display medium can comprise a self-luminous medium material or a non-self-luminous medium material. The display interconnections 106 pass through the opening holes 107. The display material DM is driven by the sensing and driving function element 10 (no shown; same as FIG. 20) through the display interconnection lines PL1˜PLn and second touch interconnection line TL3B.

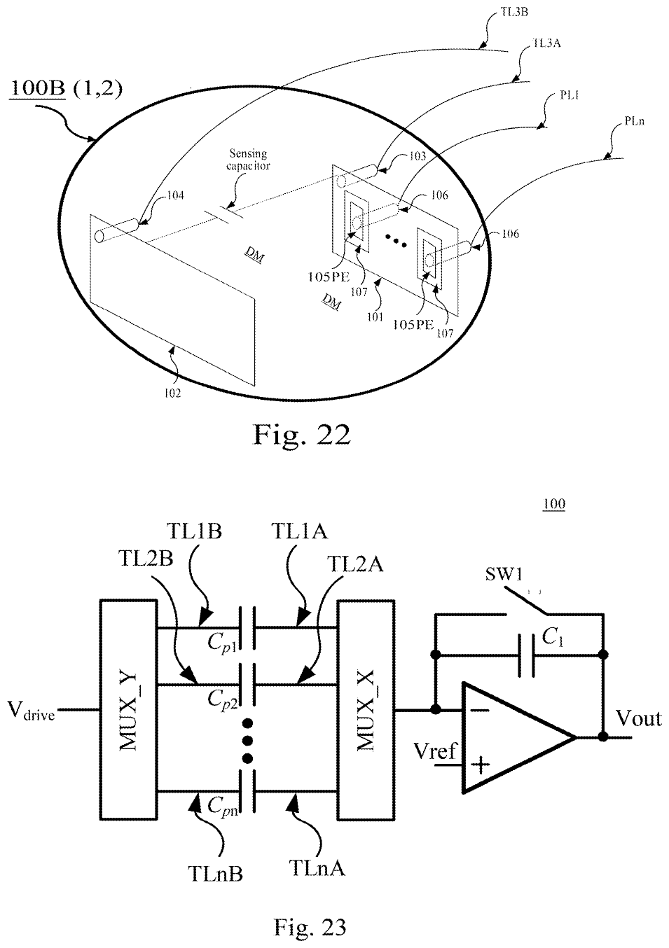

FIG. 22 is another diagram of the touch and display device 100B showing that the touch and display device 100B comprises a first electrode 101, a second electrode 102, a first touch interconnection 103 electrically coupled to the first electrode 101, a second touch interconnection 104 electrically coupled to the second electrode 102, a first touch interconnection line TL3A electrically coupled to the first touch interconnection 103, a second touch interconnection line TL3B electrically coupled to the touch interconnection 104, a plurality of display electrodes 105PE, a display medium DM, a plurality of display interconnections 106 electrically coupled to the display electrodes 105PE, a plurality of opening holes 107, and a plurality of display interconnection lines PL1˜PLn electrically coupled to the display interconnections 106. The first electrode 101 and the second electrode 102 form a sensing capacitor. The capacitance of the sensing capacitor can be detected by the sensing and driving function element 10 (no shown; same as FIG. 20) through the first touch interconnection line TL3A and the second touch interconnection line TL3B. The display medium DM is disposed between the display electrode 105PE and the second electrode 102. The display medium DM can comprise a self-luminous medium material or a non-self-luminous medium material. The display electrodes 105PE and the first electrode 101 are on the same layer, but they are separate. The display material DM is driven by the sensing and driving function element 10 (no shown; same as FIG. 20) through the display interconnection lines PL1˜PLn and second touch interconnection line TL3B.

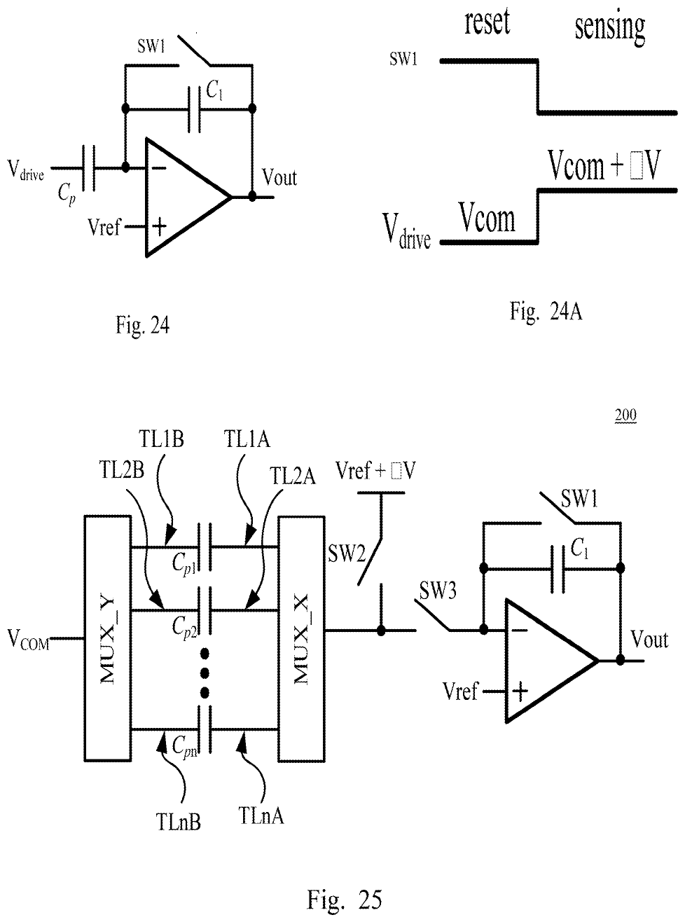

FIG. 23 is a schematic circuit diagram of a sensor circuit of an embodiment of the present invention for sensing the capacitances of the plurality of touch and display devices 100. The sensing circuit can comprise a first multiplexer MUX X electrically coupled to the plurality of sensing devices through the plurality of the first touch interconnection lines TL1A˜TLnA for sensing the capacitances (C_{P1} to C_{Pn)} for one of the sensing devices, a second multiplexer MUX_Y electrically coupled to the plurality of sensing devices through the plurality of the second touch interconnection lines TL1B˜TLnB and electrically coupled to a driver voltage Vdrive, the non-inverting input terminal of an operational amplifier AO1 electrically coupled to a reference voltage Vref and the inverting input terminal of the operational amplifier AO1 electrically coupled to the first multiplexer MUX_X for transferring the charge from the selected sensing device, a capacitor C1 electrically coupled to the selected sensing device for receiving the charge and coupled to the output of the operational amplifier AO1, and a switch SW1 electrically coupled to the two ends of the capacitor C1 for resetting the capacitor.

FIG. 24 is a schematic circuit diagram of the sensing circuit of FIG. 23 for sensing the capacitance C_{P} of the selected, wherein is located or identified the position through addressing selection circuit or MUX circuits decoded (do not shown). The first terminal of the selected sensing device electrically coupled to a driving voltage Vdrive and the second terminal of the selected sensing device electrically coupled to the inverting input terminal of the operational amplifier AO1. A drive voltage Vdrive is applied to the sensing device to sense the selected capacitance of the sensing device.

FIG. 24A is a waveform diagram of the operation of the sensing schematic circuit of FIG. 24. Two phases are required for sensing the capacitance of the sensing device. The first phase is reset, and the second phase is sensing. During the reset phase, a voltage Vcom is applied to the common backside (the second electrode 102) of the sensing devices, and the switch SW1 is turned on. Then the operational amplifier becomes a unity-gain buffer, and the charge of the capacitor C1 is reset to zero. The voltage difference between the two ends of the sensing device is Vcom−Vref. The charge stored on the sensing device is Cp (Vcom−Vref). During the second phase, the switch C1 is turned off first, and then the common backside of the sensing device is driven to a voltage of Vcom+ΔV. Part of the charge of the sensing device is transferred to C1. The output voltage becomes Vref−ΔV (Cp/C1). From the output reduced voltage ΔV (Cp/C1), the capacitance Cp of the sensing device can be found.

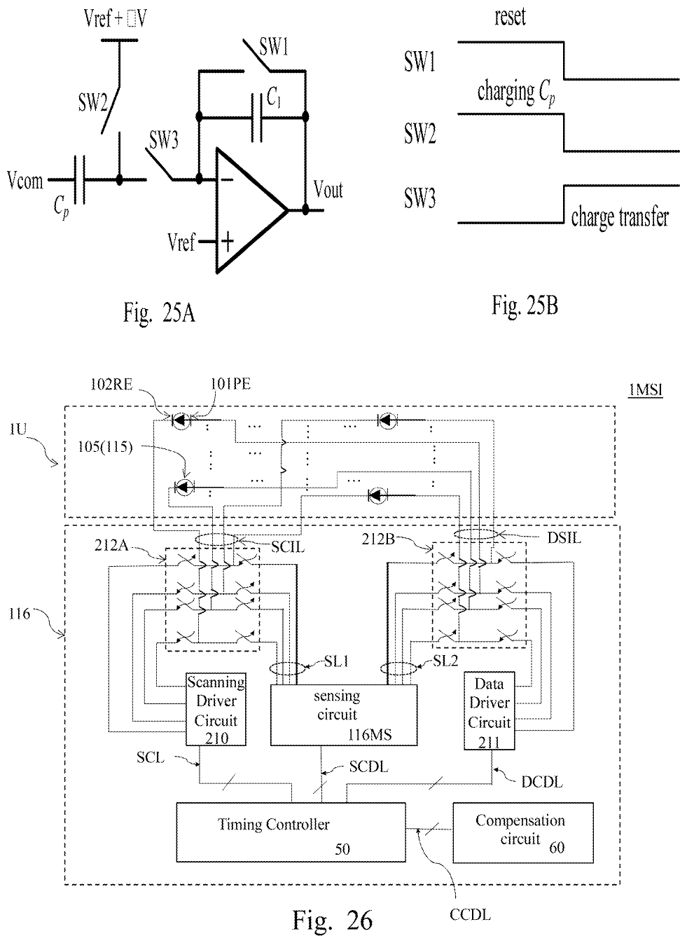

FIG. 25 is a diagram of another sensor circuit of an embodiment of the present invention for sensing capacitances of sensor devices 200. The sensing circuit can comprise a first multiplexer MUX X electrically coupled to the plurality of sensing devices through the plurality of the first touch interconnection lines TL1A˜TLnA for sensing the capacitances (C_{P1} to C_{Pn}) for one of the sensing devices, a second multiplexer MUX_Y electrically coupled to the plurality of sensing devices through the plurality of the second touch interconnection lines TL1B˜TLnB and coupled to a common voltage VCOM, a switch SW2 electrically coupled to the output of the first multiplexer MUX_X for driving a voltage Vref+ΔV to the selected sensing device, a switch SW3 electrically coupled to the output of the first multiplexer MUX_X for charge transfer, the non-inverting input terminal of an operational amplifier electrically coupled to a reference voltage Vref and the inverting input terminal electrically coupled to the switch SW3 for transferring the charge from the selected sensing device, a capacitor C1 electrically coupled to the switch SW3 for receiving the charge, and a switch SW1 electrically coupled to the two ends of the capacitor C1 for resetting the capacitor.

FIG. 25A is a schematic circuit diagram of the sensing circuit of FIG. 25 for sensing the capacitance of the selected sensing device. The selected sensing device coupled to the switches SW2 and SW3. A common voltage Vcom is applied to the common-backside end (the second electrode 102) of the sensing device. FIG. 25B is a waveform diagram of the operation of the sensing circuit of FIG. 25A. Two phases are required for sensing the capacitance of the sensing device. During the first phase, a common voltage Vcom is applied to the common backside end (the second electrode 102) of the sensing devices, switches SW1 and SW2 are turned on, and switch SW3 is turned off. Then the operational amplifier becomes a unity-gain buffer, and the charge of the capacitor C1 is reset to zero. A voltage Vref+ΔV is applied to the selected sensing device. The voltage difference between the two ends of the sensing device is Vcom−Vref−ΔV. The charge stored on the sensing device is Cp (Vcom−Vref−ΔV). During the second phase, the switches SW1 and SW2 are turned off first, and then the switch SW3 is turned on. Part of the charge of the sensing device is transferred to C1. The output voltage of the operational amplifier becomes Vref−ΔV (Cp/C1). From the output voltage, the capacitance Cp of the sensing device can be found.

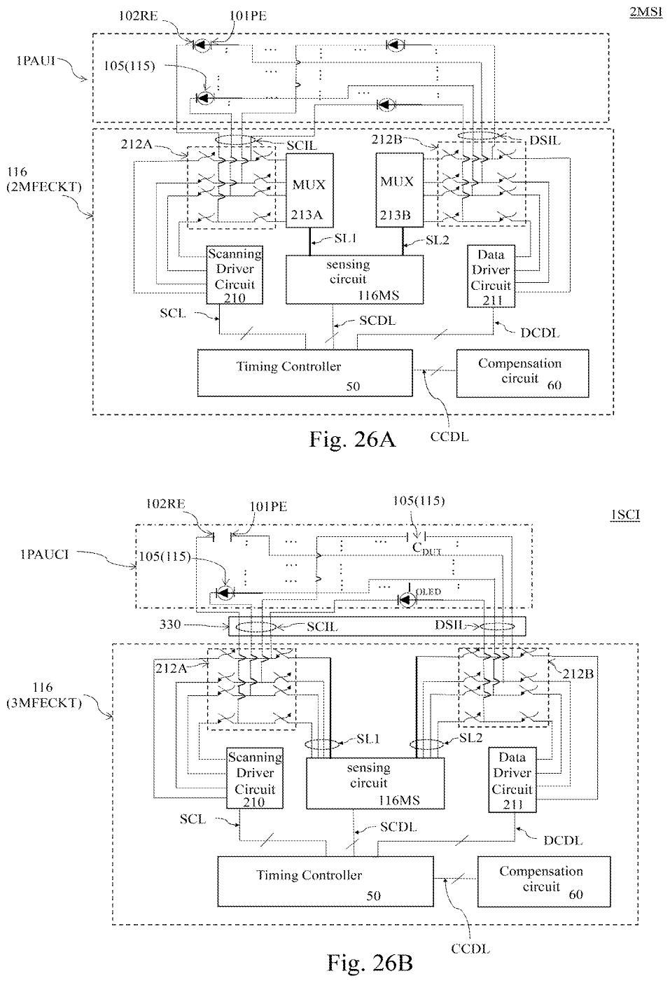

Please refer to FIG. 26, showing a schematic diagram 1MSI for sensing, driving, measuring and/or compensating the characteristics of the display medium of the present invention referred from FIG. 2 to FIG. 25. The diagram 1MSI comprises a display medium module 1PAUI (not only limited in the current mode medium shown in FIG. 26) and an active switching element 116, wherein the transistors 116T of the active switching element 116 could be constructed into a sensing and driving function element circuit diagram 1MFECKT electrically coupled to, the first electrode 101PE and the second electrode 102RE, and configured to sense, drive, measure and/or compensate the characteristics of the display medium module 1PAUI. The circuit diagram 1MFECKT comprises a scanning driver circuit block 210, a data driver circuit block 211, a sensing circuit block 116MS, multiple switch blocks 212A-212B, a timing controller circuit block 50, a compensation circuit block 60, a scanning control lines SCIL, and a driving and sensing control lines DSIL. The timing controller circuit block 50 controls the operation of the scanning driver circuit block 210, data driver circuit block 211, sensing circuit block 116MS and compensation circuit block 60 through inter-control lines (EX. SCL, SCDL, DCDL and CCDL) of the circuit diagram 1MFECKT during different timing operation periods. During driving period, the scanning control lines SCIL are connected to the scanning driver circuit block 210 and the driving and sensing control lines DSIL are connected to the data driver circuit block 211 through the multiple switch blocks 212A-212B. The scanning driver circuit block 210 can control the corresponding display medium module 1PAUI through the scanning control lines SCIL and the data driver circuit block 211 can send the image data to the corresponding display medium module 1PAUI through the driving and sensing control lines DSIL. Normally, the compensation circuit block 60 can generate the compensated driving data for achieving the uniform characteristics of the display medium module 1PAUI. The operation of the compensation circuit block 60 is controlled and the compensated driving data is sent to the data driver circuit block 211 by the timing controller circuit block 50. During the sensing period, the scanning control lines SCIL and the driving and sensing control lines DSIL are connected to the sensing circuit block 116MS through the multiple switch blocks 212A-212B and sensing lines SL1 and SL2, wherein the first electrode 101PE and the second electrode 102RE of the selected display medium are connected to the sensing circuit block 116MS for sensing and measuring the characteristics of the display medium module 1PAUI of FIG. 26. The active switching element 116, wherein the transistors 116T of the active switching element 116 could be constructed into a circuit diagram 1MFECKT coupled to, the first electrode 101PE and the second electrode 102RE, and configured to sense, drive, measure and/or compensate the characteristics of the display medium module 1PAUI referred from FIG. 2 to FIG. 25, and also could provide touch, data transmission, data stored, photography, power generation differently functional elements and so on.

Please refer to FIG. 26A, showing another schematic diagram 2MSI for sensing, driving, measuring and/or compensating the characteristics of the display medium of the present invention (referred shown from FIG. 2 to FIG. 25). The diagram 1MSI comprises a display medium module 1PAUI (not only limited in the current mode medium shown in FIG. 26) and an active switching element 116, wherein the transistors 116T of the active switching element 116 could be constructed into another sensing and driving function element circuit diagram 2MFECKT; and electrically coupled to, the first electrode 101PE and the second electrode 102RE, and configured to sense, drive, measure and/or compensate the characteristics of the display medium module 1PAUI. The circuit 2MFECKT comprises a scanning driver circuit block 210, a data driver circuit block 211, a sensing circuit block 116MS, multiplexer blocks 213A-213B, multiple switch blocks 212A-212B, a timing controller circuit block 50, a compensation circuit block 60, a scanning control lines SCIL, and a driving and sensing control lines DSIL. The timing controller circuit block 50 controls the different operation of the scanning driver circuit block 210, data driver circuit block 211, sensing circuit block 116MS and compensation circuit block 60 during different timing periods, through inter-control lines (EX. SCL, SCDL, DCDL and CCDL) of the circuit 2MFECKT. The circuit diagram 2MFECKT could further comprises multiplexer blocks 213A-213B to combine with switch blocks 212A-212B for sensing and measuring one of the display media in the display medium module 1PAUI through the sensing line SL1 and SL2 (not only limited using on sense circuit block).

During driving period, the scanning control lines SCIL are connected to the scanning driver circuit block 210 and the driving and sensing control lines DSIL are connected to the data driver circuit block 211 through the multiple switch blocks 212A-212B. Furthermore, the scanning driver circuit block 210 can control the corresponding display medium module 1PAUI through the scanning control lines SCIL and the data driver circuit block 211 can send the image data to the corresponding display medium module 1PAUI through the driving and sensing control lines DSIL. Normally, the compensation circuit block 60 can be used generated the compensated driving data for achieving the uniform characteristics of the display medium module 1PAUI, thereof the operation of the compensation circuit block 60 is controlled and the compensated driving data is sent to the data driver circuit block 211 by the timing controller circuit block 50. During the sensing period, the scanning control lines SCIL and the driving and sensing control lines DSIL are electrically connected to the sensing circuit block 116MS through the multiplexer blocks 213A-213B to combine with switch blocks 212A-212B and sensing line SL1 and SL2, therefore the first electrode 101PE and the second electrode 102RE of the selected display medium are electrically connected to the sensing circuit block 116MS for sensing and measuring one of the characteristics of the display medium module 1PAUI in FIG. 26A. The active switching element 116, wherein the transistors 116T of the active switching element 116 be constructed into a circuit diagram 2MFECKT coupled to the first electrode 101PE and the second electrode 102RE, and configured to sense, drive, measure and/or compensate the characteristics of the display medium module 1PAUI in FIG. 25, and the circuit diagram 2MFECKT also could provide touch, data transmission, data stored, photography, power generation differently functional elements and so on.

Please refer to FIG. 26B, showing another schematic diagram 1SCI for sensing, driving, measuring and/or compensating the characteristics of the display medium of the present invention (referred shown from FIG. 2 to FIG. 25). The diagram 1SCI comprises a display medium module 1PAUCI (shown current and capacitor mode display medium at the same display module), a connecting module 330 (descripted previously in FIG. 8 to FIG. 8B), and the transistors 116T of the active switching element 116 are constructed into another sensing and driving function element circuit diagram 3MFECKT coupled to the first electrode 101PE and the second electrode 102RE; and configured to sense, drive, measure and/or compensate the characteristics of the display medium module 1PAUCI. The circuit 3MFECKT comprises a scanning driver circuit block 210, a data driver circuit block 211, a sensing circuit block 116MS, multiple switch blocks 212A-212B, a timing controller circuit block 50, a compensation circuit block 60, a scanning control lines SCIL, and a driving and sensing control lines DSIL (do not shown multiplexer blocks). The timing controller circuit block 50 controls the operation of the scanning driver circuit block 210, data driver circuit block 211, sensing circuit block 116MS and compensation circuit block 60 through inter-control lines (EX. SCL, SCDL, DCDL and CCDL) of the circuit 3MFECKT during different timing operation periods. During driving period, the scanning control lines SCIL are connected to the scanning driver circuit block 210 and the driving and sensing control lines DSIL are electrically connected to the data driver circuit block 211 through the multiple switch blocks 212A-212B. The scanning driver circuit block 210 can control the corresponding display medium module 1PAUCI through the scanning control lines SCIL and the data driver circuit block 211 can send the image data to the corresponding display medium module 1PAUI through the driving and sensing control lines DSIL. Normally, the compensation circuit block 60 can be used generated the compensated driving data for achieving the uniform characteristics of the display medium module 1PAUI. The operation of the compensation circuit block 60 is controlled and the compensated driving data is sent to the data driver circuit block 211 by the timing controller circuit block 50. During the sensing period, the scanning control lines SCIL and the driving and sensing control lines DSIL are connected to the sensing circuit block 116MS through the switch blocks 212A-212B and sensing lines SL1 and SL2, wherein the first electrode 101PE and the second electrode 102RE of the selected display medium are connected to the sensing circuit block 116MS for sensing and measuring one of the characteristics of the display medium module 1PAUCI in FIG. 26B. The transistors 116T of the active switching element 116 (sensing circuit 116MS) be constructed into a circuit diagram 3MFECKT coupled to, the first electrode 101PE and the second electrode 102RE, and configured to sense, drive, measure and/or compensate the characteristics of the display medium module 1PAUI referred from FIG. 2 to FIG. 25, and also could provide touch, data transmission, data stored, photography, power generation differently functional elements and so on.

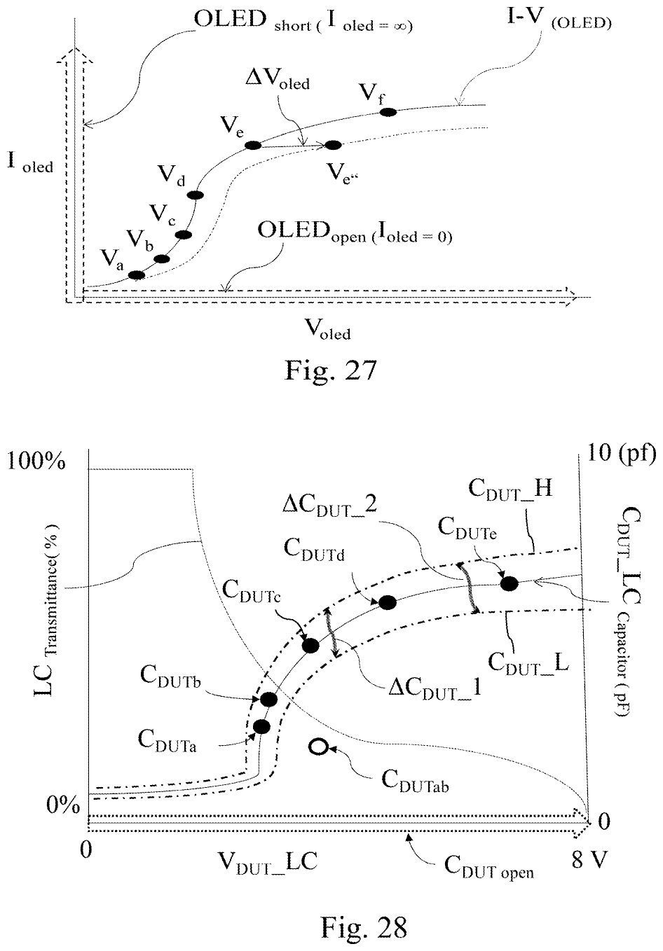

FIG. 27 shows a measured I-V curve characteristics of the display medium module (used OLED as sample) of the present invention referred from FIG. 2 to FIG. 26B. The measured I-V curve characteristics of the OLED display medium module that could present the characteristics of the OLED display medium pixels at any stage. An advantage of this invention is an OLED display medium that sense, measure, drive and/or compensates for differences in characteristics by each of OLED display medium pixels, and identify the initial nonuniformity or detect open/short of the display medium pixels in any stage, without complex circuitry for accumulating a continuous measurement of OLED display medium after stressed time of period. However, such characteristics of the OLED display medium pixels suffer from a variety of defects that limit the quality of the displays. In particular, OLED displays suffer from invisible or visible nonuniformities in the pixels across a display. These nonuniformities can be attributed from OLED emitters medium during manufacturing or after ageing, and the transistors 116T of the active switching element 116 (sensing circuit 116MS) could be constructed and configured for sensing, driving, measuring and/or compensating the characteristics of the display medium module, by electrically coupled to the first electrode 101PE and the second electrode 102RE. The I-V characteristics variability of transistors 116T of active switching elements on wafer silicon is much smaller than the thin-film transistors currently used to drive the OLED emitters. Normally, the unacceptable display performance of luminance varied solved by adding more thin-film transistors in each OLED pixel now. The ΔVoled could be presented the initial display medium non-uniform characteristics between sub-pixels of display array or the deviations between sub-pixels after aged shown in FIG. 27. By making all sensitivities and measurements of voltage in driving transistor properties can be performed with compensation for providing a precise compensation solution by using effective active switching element 116 (sensing circuit 116MS). A selected single display pixel medium characteristics variability could be combined with the internal multiplexers and switches circuit blocks to enable input and readout data easily and cost-effectively.

FIG. 28 shows a measured C-V curve characteristics of the display medium module (used liquid crystal as sample) of the present invention referred from FIG. 2 to FIG. 26B. The measured C-V curve characteristics of the liquid crystal display medium module that could present the characteristics of the LC display medium pixels at any stage. An advantage of this invention is an LC display medium that sense, measure, drive and/or compensates for differences in characteristics by each of LC display medium pixels, and identify the initial nonuniformity or detect open/short of the display medium pixels in any stage, without complex circuitry for accumulating a continuous measurement of LC display medium after stressed time of period. However, such characteristics of the LC display medium suffer from a variety of defects that limit the quality of the displays. In particular, LC displays suffer from invisible or visible nonuniformities in the pixels across a whole display, wherein nonuniformities can be attributed from liquid crystal display medium during manufacturing or after ageing. The transistors 116T of the active switching element 116 (sensing circuit 116MS) could be constructed and configured for sensing, driving, measuring and/or compensating the characteristics of the display medium module, by electrically coupled to the first electrode 101PE and the second electrode 102RE. The electronic characteristics variability of transistors 116T of active switching elements 116 (sensing circuit 116MS) on wafer silicon is much smaller than the thin-film transistors currently used to drive the liquid crystal display medium. The ΔC_{DUT} could be presented the initial display medium non-uniform characteristics between sub-pixels of display array or the deviations between sub-pixels after aged shown in FIG. 28. By making all sensitivities and measurements of capacitor can be performed with compensation for providing a precise compensation solution by using effective active switching element 116 (sensing circuit 116MS). A selected single display pixel medium characteristics variability could be combined with the internal multiplexers and switches circuit blocks to enable input and readout data easily and effectively.

Those skilled in the art will readily observe that numerous modifications and alterations of the device and method may be made while retaining the teachings of the invention. Accordingly, the above disclosure should be construed as limited only by the metes and bounds of the appended claims.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A pixel array comprising:
a plurality of pixel units, wherein each pixel units comprises:
a display media module comprising one or more pairs of electrodes and display media, each pair of electrodes comprising a first electrode disposed on a first substrate and a second electrode, and the display medium being disposed between the first electrode and the second electrode; and
a sensing function element constructed from an active switch element, wherein the active switching element comprises a substrate portion and a transistor portion formed on the substrate portion, and wherein the transistors constructed into one or more gain stages or feedback loops; and
wherein the sensing function element is independently manufactured from the display media module and electrically coupled to the first electrodes of the display media module, and configured to provide electric energy between the first electrode and the second electrode for sensing, measuring or compensating the characteristics of the display media to adjust the amount of light passing through the display media.

2. The pixel array of claim 1, wherein the display media module further comprises the first substrate and a second substrate, which are disposed facing each other and separated from each other;
wherein the second electrode is disposed on the first substrate or the second substrate.

3. The pixel array of claim 2, wherein the first electrode or the second electrode is made of the following transparent conductive material, non-transparent conductive material, flexible conductive material, rigid conductive material, metallic conductive material, metal alloy material, organic conductive material, inorganic conductive material, composite conductive material, and one of combinations thereof.

4. The pixel array of claim 1, wherein each of the pixel unit further comprises a package carrier, therein is assembled the sensing function element.

5. The pixel array of claim 4, wherein each of the pixel unit further comprises a functional element assembled in the package carrier, wherein the functional element comprising at least one of a displacement sensing functional element, a hygrothermal sensing functional element, an acoustic sensing functional element, an electromagnetic sensing functional element, a touch sensing functional element, an image capturing functional element, a memory functional element, a control functional element, a wireless communication functional element, a passive functional element, a self-luminous functional element and a photovoltaic functional element.

6. The pixel array of claim 2, wherein the first substrate or the second substrate comprise a concave groove or a through hole, and the sensing function element is disposed in the concave groove or the through hole.

7. The pixel array of claim 1, wherein the pixel units further comprise an optical element optically coupled with the display media and the optical element comprises at least one of a convex lens, a concave lens and an optical prism.

8. The pixel array of claim 1, wherein the display media comprises at least one of self-luminous medium material, non-self-luminous medium material, light-filtering material, electric conductive material, insulating material, light absorbing material, light reflecting material, photorefractive material, light deflecting material and light diffusing material.

9. The pixel array of claim 8, wherein the non-self-luminous medium material comprises at least one of electrophoretic material, electric fluid material, liquid crystal material, micro electromechanical reflective material, electrowetting material, electric ink material, magnetic fluid material, electrochromic material, electromorphous material and thermochromic material; the self-luminous medium material comprises at least one of electroluminescent material, photoluminescent material, cathodoluminescent material, field emissive luminescent material, vacuum fluorescent material and light-emitting diode material.

10. The pixel array of claim 1, wherein the shape of the display media module is square, rectangular, fan-shaped, triangular, trapezoid, round, polygonal, irregular, or one of the combinations thereof.

11. The pixel array of claim 1, further comprising a connecting module being separately manufactured and combined with the display media module or the sensing function element, wherein the connecting module is a pitch connector, and the pitch between two connectors electrically connecting with the sensing function elements is less than the pitch between two connectors connecting with the first electrodes.

12. The pixel array of claim 11, wherein the connecting module being characterized as an interposer is disposed, assembled, bonded, combined, merged, associated, linked, embedded or integrated with the display media module or the sensing function elements.

13. The pixel array of claim 1, the gain stages of the sensing function elements further comprises one or more differential amplifiers and one or more switches, wherein constructed from the transistors of the active switch elements, one or more switch capacitors or resistors; wherein the switch capacitors, switch resistors or switches are electrically coupled to the inverting input terminal and output terminal of the differential amplifier to form a closed loop; wherein the first electrode of the display media electrically coupled to the inverting input terminal of the differential, the second electrode of the display media electrically connected to ground, a dc voltage or the inverting input terminal of another differential; and wherein during a reset phase or a sensing phases of the sensing function elements, by modulating an appropriate voltages electrically coupled to the non-inverting input terminal of the differential amplifiers, by setting an appropriate switch capacitors or switch resistors values, and by appropriate controlling the switches; and whereof the sensing function elements configured to provide electric energy between the first electrode and the second electrode for sensing, measuring or compensating the characteristics of the display media to adjust the amount of light passing through the display media.

14. A touch electronic display apparatus comprising:
a plurality of touch and display devices comprises:
a first electrodes, a second electrodes, a first touch interconnections and a second touch interconnections, wherein a first touch interconnection lines electrically coupled to the first touch interconnections and the first electrodes and a second touch interconnection lines electrically coupled to the second touch interconnections and the second electrodes;
a plurality of display interconnection lines through a plurality of open holes electrically coupled to a plurality of display interconnections and a plurality of display electrodes; and
a display medium,
wherein the display medium being deposed between the display electrodes and the second electrodes, and the first electrodes and the second electrodes being formed a sensing capacitor; and
a sensing and driving function element constructed from a plurality of transistors of the active switching element;
wherein a detected one of the sensing capacitors through touch the interconnection lines electrically coupled to the first and second touch interconnections for sensing the sensing capacitor by the sensing and driving function element, and a driven display medium through the display interconnection lines electrically coupled to the display electrodes and the second electrode for driving the display medium by the sensing and driving function element.

15. The touch electronic display apparatus of claim 14, wherein the display electrode and the first electrode on the same layer, but separated each other.

16. The touch electronic display apparatus of claim 14, wherein the sensing and driving function element further comprising:
a first multiplexer and a second multiplexer, wherein the first and the second multiplexer through a plurality of the first and second touch interconnection lines electrically coupled to the sensing capacitor;
a plurality of the switches and a capacitor;
a reference voltage electrically coupled to a non-inverting terminal of an operational amplifier and an inverting terminal of the operational amplifier electrically coupled to the first multiplexer or switch for transferring a charge from the selected sensing capacitor; and
a driver or common voltage electrically coupled to the second multiplexer;
wherein the capacitor electrically coupled to the selected of the sensing capacitor and coupled the output terminal of the operational amplifier, and the switch electrically coupled to the two ends of the capacitor; and a selected sensing capacitor through addressing selection or multiplexer decoded circuits, by appropriate controlling the switches and modulating the driver or reference voltage to sense the location of the selected sensing capacitor.

17. A display apparatus comprising:
a display media module comprising one or more pairs of
electrodes and one or more display media, each pair of electrodes comprising a first electrode disposed on a first substrate and a second electrode, and the display medium being disposed between the first electrode and the second electrode; and
a sensing and driving function element, wherein constructed from a plurality of transistors of an active switching element, comprising:
a timing controller controls different operations of a scanning driver circuit block, a data driver circuit block, a sensing circuit block, and a compensation circuit block through a plurality of inter-control lines;
wherein the sensing circuit block, the data driver circuit block and scanning driver circuit block through a plurality of inter-control lines and sensing lines to control a plurality of multiplexer and switch blocks for sensing, measuring and driving one of the display media,
wherein the sensing and driving function element electrically coupled to the first and second electrodes of the display media configured to sense, drive, measure or compensate the characteristics of the display media being deposed between the first and the second electrodes on the driving or sensing period.

18. The display apparatus of claim 17, further comprising a connecting module electrically coupled between the electrodes of display media and the plurality of switch blocks.

19. The display apparatus of claim 17, wherein the display media comprising comprises at least one of self-luminous medium material, non-self-luminous medium material, light-filtering material, electric conductive material, insulating material, light absorbing material, light reflecting material, photorefractive material, light deflecting material and light diffusing material;
wherein the non-self-luminous medium material comprises at least one of electrophoretic material, electric fluid material, liquid crystal material, micro electromechanical reflective material, electrowetting material, electric ink material, magnetic fluid material, electrochromic material, electromorphous material and thermochromic material; the self-luminous medium material comprises at least one of electroluminescent material, photoluminescent material, cathodoluminescent material, field emissive luminescent material, vacuum fluorescent material and light-emitting diode material; and
wherein the shape of the display media module is square, rectangular, fan-shaped, triangular, trapezoid, round, polygonal, irregular, or one of the combinations thereof.
